(19) United States
(12) Patent Application Publication
(10) Pub. No.: US 2025/0317599 A1
(43) Pub. Date: Oct. 9, 2025

(54) METHOD, APPARATUS, AND MEDIUM FOR VIDEO PROCESSING

(71) Applicant: Bytedance Inc., Los Angeles, CA (US)

(72) Inventors: Mehdi SALEHIFAR, Los Angeles, CA (US); Yuwen HE, Los Angeles, CA (US); Kai ZHANG, Los Angeles, CA (US); Li ZHANG, Los Angeles, CA (US)

(21) Appl. No.: 19/245,169

(22) Filed: Jun. 20, 2025

Related U.S. Application Data
(63) Continuation of application No. PCT/US2023/084955, filed on Dec. 19, 2023.
(60) Provisional application No. 63/476,591, filed on Dec. 21, 2022.

(51) Int. Cl. H04N 19/577; H04N 19/176; H04N 19/513

(52) U.S. Cl. CPC H04N 19/577; H04N 19/176; H04N 19/513

(57) ABSTRACT

Embodiments of the present disclosure provide a solution for video processing. A method for video processing is proposed. The method comprises: obtaining, for a conversion between a current video block of a video and a bitstream of the video, a plurality of weights, wherein the plurality of weights are used to weight a plurality of values for a metric at respective samples in a target region for a bi-directional optical flow (BDOF) process applied on the current video block, the metric comprises at least one of a gradient or a difference of sample values, and the plurality of values for the metric are determined based on a plurality of reference video blocks of the current video block; and performing the conversion based on the plurality of weights.

### CROSS REFERENCE

This application is a continuation of International Application No. PCT/US2023/084955, filed on Dec. 19, 2023, which claims the benefit of U.S. Provisional Application No. 63/476,591, filed on Dec. 21, 2022. The entire contents of these applications are hereby incorporated by reference in their entireties.

### FIELDS

Embodiments of the present disclosure relates generally to video processing techniques, and more particularly, to a bi-directional optical flow (BDOF) process.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding quality of video coding techniques is generally expected to be further improved.

### SUMMARY

Embodiments of the present disclosure provide a solution for video processing.

In a first aspect, a method for video processing is proposed. The method comprises: obtaining, for a conversion between a current video block of a video and a bitstream of the video, a plurality of weights, wherein the plurality of weights are used to weight a plurality of values for a metric at respective samples in a target region for a bi-directional optical flow (BDOF) process applied on the current video block, the metric comprises at least one of a gradient or a difference of sample values, and the plurality of values for the metric are determined based on a plurality of reference video blocks of the current video block; and performing the conversion based on the plurality of weights.

According to the method in accordance with the first aspect of the present disclosure, a plurality of weights are used to weight a plurality of values for the metric at respective samples in a target region for the BDOF process. Compared with the conventional solution where no weight is used, in aid of the plurality of weights, the proposed method can advantageously determine one or more parameter for the BDOF process by taking the importance of samples in the target region into consideration. Thereby, the coding quality can be improved.

In a second aspect, an apparatus for video processing is proposed. The apparatus comprises a processor and a non-transitory memory with instructions thereon. The instructions upon execution by the processor, cause the processor to perform a method in accordance with the first aspect of the present

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a video which is generated by a method performed by an apparatus for video processing. The method comprises: obtaining a plurality of weights, wherein the plurality of weights are used to weight a plurality of values for a metric at respective samples in a target region for a bi-directional optical flow (BDOF) process applied on a current video block of the video, the metric comprises at least one of a gradient or a difference of sample values, and the plurality of values for the metric are determined based on a plurality of reference video blocks of the current video block; and generating the bitstream based on the plurality of weights.

In a fifth aspect, a method for storing a bitstream of a video is proposed. The method comprises: obtaining a plurality of weights, wherein the plurality of weights are used to weight a plurality of values for a metric at respective samples in a target region for a bi-directional optical flow (BDOF) process applied on a current video block of the video, the metric comprises at least one of a gradient or a difference of sample values, and the plurality of values for the metric are determined based on a plurality of reference video blocks of the current video block; generating the bitstream based on the plurality of weights; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates extended coding unit (CU) region used in BDOF;

FIG. 5 illustrates decoding side motion vector refinement;

FIG. 6 illustrates diamond regions in the search area;

FIG. 7 illustrates weights generated with an example Gaussian distribution;

FIG. 8 illustrates weights generated with a further example Gaussian distribution;

FIG. 9 illustrates weights generated with a still further example Gaussian distribution;

FIG. 10 illustrates weights generated with a still further example Gaussian distribution;

FIG. 11 illustrates different filter shapes applied on the data;

FIG. 12 illustrates a flowchart of a method for video processing in accordance with embodiments of the present disclosure; and

FIG. 13 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

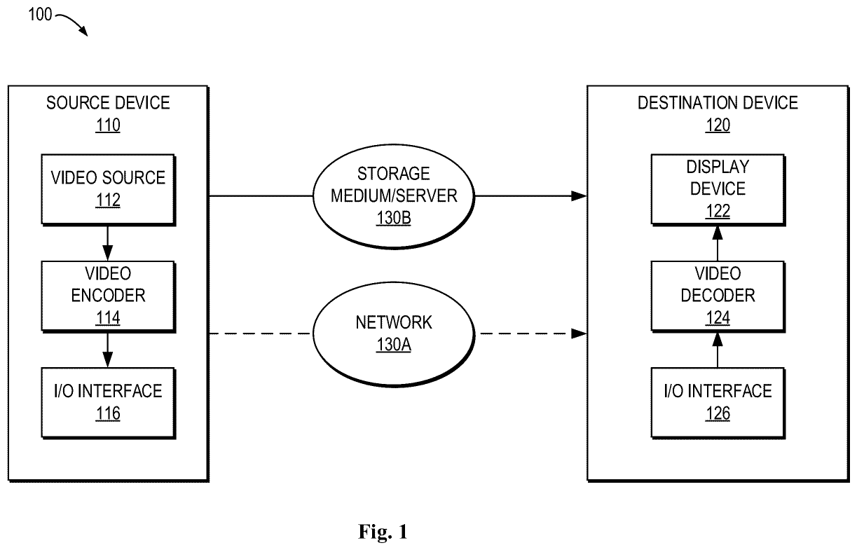

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

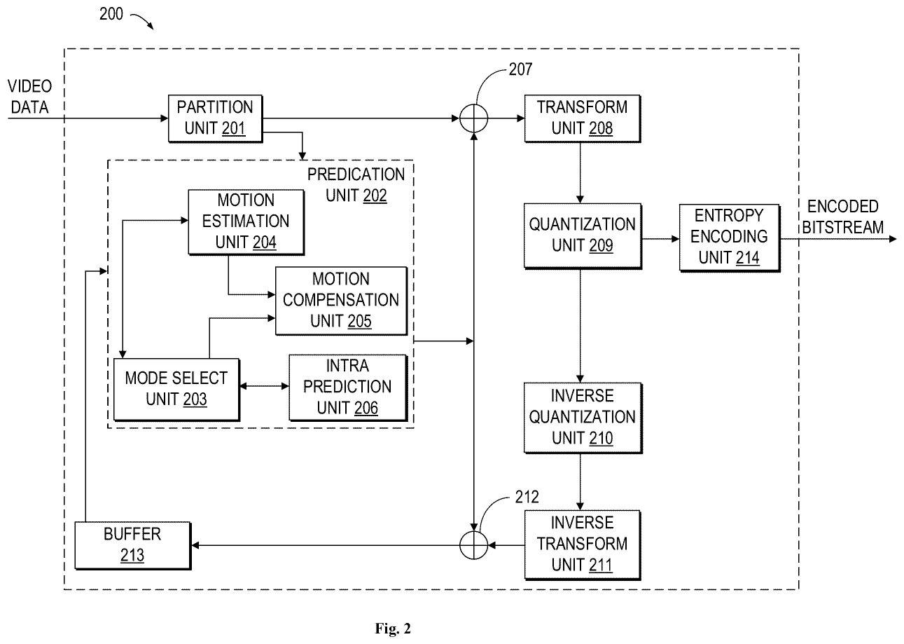

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a prediction unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the prediction unit 202 may include an intra block copy (IBC) unit. The IBC unit may perform prediction in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter prediction (CIIP) mode in which the prediction is based on an inter prediction signal and an intra prediction signal. The mode select unit 203 may also select a resolution for a motion vector (e.g., a sub-pixel or integer pixel precision) for the block in the case of inter-prediction.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector prediction (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the prediction unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

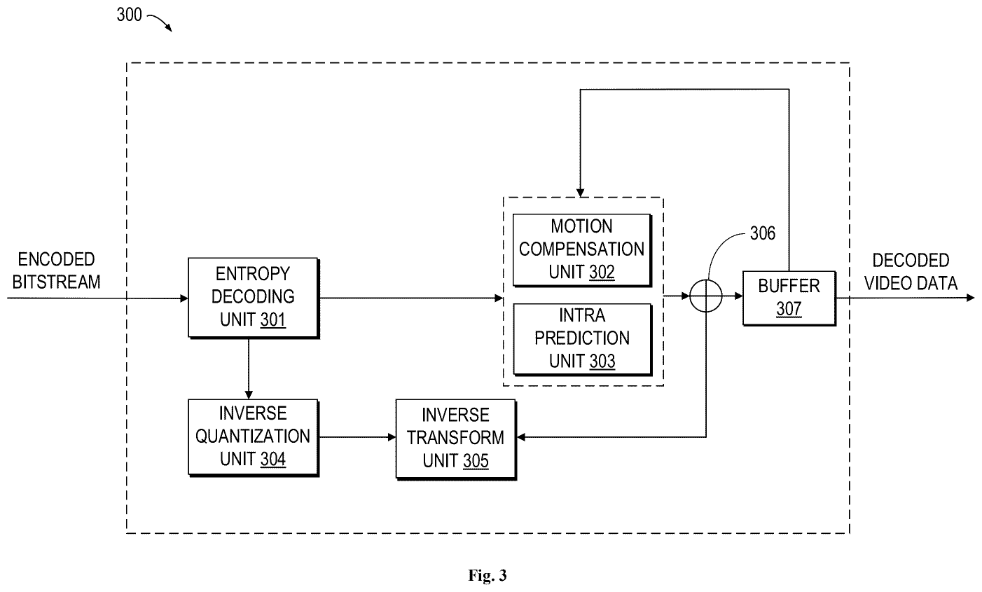

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra prediction and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. Brief Summary

This disclosure is related to video/image coding technologies. Specifically, it is related to bi-directional optical flow. It may be applied to the existing video coding standard like HEVC, VVC, or the next generation video coding standard like beyond VVC exploration such as ECM. It may also be applicable to future video coding standards or video codec.

### 2. Introduction

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, Joint Video Exploration Team (JVET) was founded by VCEG and MPEG jointly in 2015. As of July 2020, it has also finalized the Versatile Video Coding (VVC) standard, aiming at yet another 50% bit-rate reduction and providing a range of additional functionalities. After finalizing VVC, activity for beyond VVC has started. A description of the additional tools on top of the VVC tools has been summarized in M. Coban, F. Léannec, K. Naser, and J. Ström “Algorithm description of Enhanced Compression Model 5 (ECM 5),” document JVET-Z2025, 26th JVET meeting: by teleconference, 20-29 Apr. 2022., and its reference SW is named as ECM.

### 2.1 Bi-Directional Optical Flow (BDOF) in VVC

The bi-directional optical flow (BDOF) tool is included in VVC. BDOF, previously referred to as BIO, was included in the JEM. Compared to the JEM version, the BDOF in VVC is a simpler version that requires much less computation, especially in terms of number of multiplications and the size of the multiplier.

BDOF is used to refine the bi-prediction signal of a CU at the 4×4 subblock level. BDOF is applied to a CU if it satisfies all the following conditions:
The CU is coded using “true” bi-prediction mode, i.e., one of the two reference pictures is prior to the current picture in display order and the other is after the current picture in display order.
The distances (i.e. POC difference) from two reference pictures to the current picture are same.
Both reference pictures are short-term reference pictures.
The CU is not coded using affine mode or the SbTMVP merge mode.
CU has more than 64 luma samples.
Both CU height and CU width are larger than or equal to 8 luma samples.
BCW weight index indicates equal weight.
WP is not enabled for the current CU.
CIIP mode is not used for the current CU.

BDOF is only applied to the luma component. As its name indicates, the BDOF mode is based on the optical flow concept, which assumes that the motion of an object is smooth. For each 4×4 subblock, a motion refinement (vₓ, v_{y}) is calculated by minimizing the difference between the L0 and L1 prediction samples. The motion refinement is then used to adjust the bi-predicted sample values in the 4×4 subblock. The following steps are applied in the BDOF process.

First, the horizontal and vertical gradients,

$$\frac{\partial {I}^{( k )}}{\partial x} ( i , j ) and \frac{\partial {I}^{( k )}}{\partial y} ( i , j ) , k = 0 , 1 ,$$

of the two prediction signals are computed by directly calculating the difference between two neighboring samples, i.e.,

$$\frac{\partial {I}^{( k )}}{\partial x} ( i , j ) = ( ( {I}^{( k )} ( i + 1 , j ) >> shift1 ) - ( {I}^{( k )} ( i - 1 , j ) >> shift1 ) )$$

$$\frac{\partial {I}^{( k )}}{\partial y} ( i , j ) = ( ( {I}^{( k )} ( i , j + 1 ) >> shift1 ) - ( {I}^{( k )} ( i , j - 1 ) >> shift1 ) )$$

where I^{(k)}(i, j) are the sample value at coordinate (i, j) of the prediction signal in list k, k=0,1, and shift1 is calculated based on the luma bit depth, bitDepth, as shift1=max(6, bitDepth−6).

Then, the auto-and cross-correlation of the gradients, S₁, S₂, S₃, S₅ and S₆, are calculated as:

$${S}_{1} = {\sum }_{( i , j ) ∈ Ω} Abs ( {ψ}_{x} ( i , j ) ) , {S}_{3} = {\sum }_{( i , j ) ∈ Ω} θ ( i , j ) \cdot Sign ( {ψ}_{x} ( i , j ) )$$

$${S}_{2} = {\sum }_{( i , j ) ∈ Ω} {ψ}_{x} ( i , j ) \cdot Sign ( {ψ}_{y} ( i , j ) )$$

$${S}_{5} = {\sum }_{( i , j ) ∈ Ω} Abs ( {ψ}_{y} ( i , j ) ) , {S}_{6} = {\sum }_{( i , j ) ∈ Ω} θ ( i , j ) \cdot Sign ( {ψ}_{y} ( i , j ) )$$

$$where$$

$${ψ}_{x} ( i , j ) = ( \frac{\partial {I}^{( 1 )}}{\partial x} ( i , j ) + \frac{\partial {I}^{( 0 )}}{\partial x} ( i , j ) ) >> {n}_{a}$$

$${ψ}_{y} ( i , j ) = ( \frac{\partial {I}^{( 1 )}}{\partial y} ( i , j ) + \frac{\partial {I}^{( 0 )}}{\partial y} ( i , j ) ) >> {n}_{a}$$

$$θ ( i , j ) = ( {I}^{( 1 )} ( i , j ) >> {n}_{b} ) - ( {I}^{( 0 )} ( i , j ) >> {n}_{b} )$$

where Ω is a 6×6 window around the 4×4 subblock, and the values of nₐ and n_{b} are set equal to min(1, bitDepth−11) and min(4, bitDepth−8), respectively.

The motion refinement (vₓ, v_{y}) is then derived using the cross-and auto-correlation terms using the following:

$${v}_{x} = {S}_{1} > 0 ? clip 3 ( - {th}_{BIO}^{′} , {th}_{BIO}^{′} , - ( ( {S}_{3} \cdot {2}^{{n}_{b} - {n}_{a}} ) >> ⌊ {log}_{2} {S}_{1} ⌋ ) ) : 0$$

$${v}_{y} = {S}_{5} > 0 ? clip 3 ( - {th}_{BIO}^{′} , {th}_{BIO}^{′} , - ( ( {S}_{6} \cdot {2}^{{n}_{b} - {n}_{a}} - ( ( {v}_{x} {S}_{2 , m} ) << {n}_{{S}_{2}} + {v}_{x} {S}_{2 , s} ) / 2 ) >> ⌊ {log}_{2} {S}_{5} ⌋ ) ) : 0$$

where S_{2,m}=S₂>>n_{S}_{₂}, S_{2,s}=S₂& (2ⁿ^{ₛ₂}−1), th′_{BIO}=2^{max(5,BD-7)}. └⋅┘ is the floor function, and n_{S}_{₂}=12. Based on the motion refinement and the gradients, the following adjustment is calculated for each sample in the 4×4 subblock:

$$b ( x , y ) = rnd ( ( {v}_{x} ( \frac{\partial {I}^{( 1 )} ( x , y )}{\partial x} - \frac{\partial {I}^{( 0 )} ( x , y )}{\partial x} ) + {v}_{y} ( \frac{\partial {I}^{( 1 )} ( x , y )}{\partial y} - \frac{\partial {I}^{( 0 )} ( x , y )}{\partial y} ) + 1 ) / 2 )$$

Finally, the BDOF samples of the CU are calculated by adjusting the bi-prediction samples as follows:

$${pred}_{BDOF} ( x , y ) = ( {I}^{( 0 )} ( x , y ) + {I}^{( 1 )} ( x , y ) + b ( x , y ) + {o}_{offset} ) >> shift$$

These values are selected such that the multipliers in the BDOF process do not exceed 15-bit, and the maximum bit-width of the intermediate parameters in the BDOF process is kept within 32-bit.

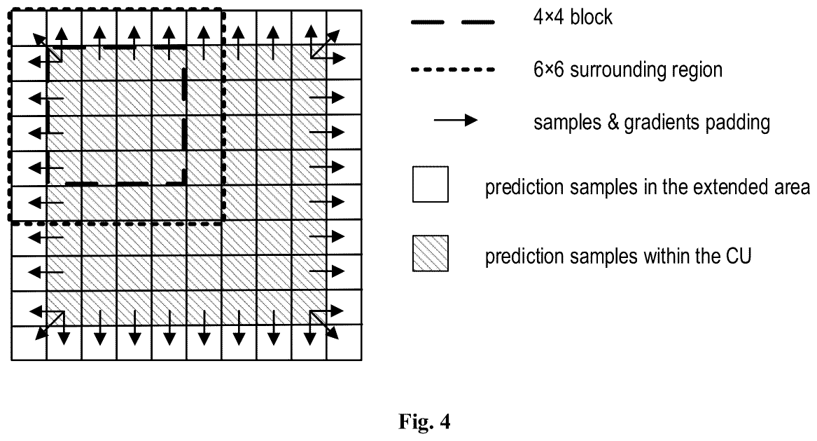

In order to derive the gradient values, some prediction samples I^{(k)}(i, j) in list k (k=0,1) outside of the current CU boundaries need to be generated. As depicted in FIG. 4, the BDOF in VVC uses one extended row/column around the CU's boundaries. In order to control the computational complexity of generating the out-of-boundary prediction samples, prediction samples in the extended area (white positions) are generated by taking the reference samples at the nearby integer positions (using floor() operation on the coordinates) directly without interpolation, and the normal 8-tap motion compensation interpolation filter is used to generate prediction samples within the CU (gray positions). These extended sample values are used in gradient calculation only. For the remaining steps in the BDOF process, if any sample and gradient values outside of the CU boundaries are needed, they are padded (i.e. repeated) from their nearest neighbors.

When the width and/or height of a CU are larger than 16 luma samples, it will be split into subblocks with width and/or height equal to 16 luma samples, and the subblock boundaries are treated as the CU boundaries in the BDOF process. The maximum unit size for BDOF process is limited to 16×16. For each subblock, the BDOF process could skipped. When the SAD of between the initial L0 and L1 prediction samples is smaller than a threshold, the BDOF process is not applied to the subblock. The threshold is set equal to (8*W*(H>>1), where W indicates the subblock width, and H indicates subblock height. To avoid the additional complexity of SAD calculation, the SAD between the initial L0 and L1 prediction samples calculated in DVMR process is re-used here.

If BCW is enabled for the current block, i.e., the BCW weight index indicates unequal weight, then bi-directional optical flow is disabled. Similarly, if WP is enabled for the current block, i.e., the luma_weight_lx_flag is 1 for either of the two reference pictures, then BDOF is also disabled. When a CU is coded with symmetric MVD mode or CIIP mode, BDOF is also disabled.

### 2.1.1 BDOF in ECM: Sample-Based BDOF

In the sample based BDOF, instead of deriving motion refinement (Vx, Vy) on a block basis, it is performed per sample.

The coding block is divided into 8×8 subblocks. For each subblock, whether to apply BDOF or not is determined by checking the SAD between the two reference subblocks against a threshold. If decided to apply BDOF to a subblock, for every sample in the subblock, a sliding 5×5 window is used and the existing BDOF process is applied for every sliding window to derive Vx and Vy. The derived motion refinement (Vx, Vy) is applied to adjust the bi-predicted sample value for the center sample of the window.

### 2.2 Decoder Side Motion Vector Refinement (DMVR) in VVC

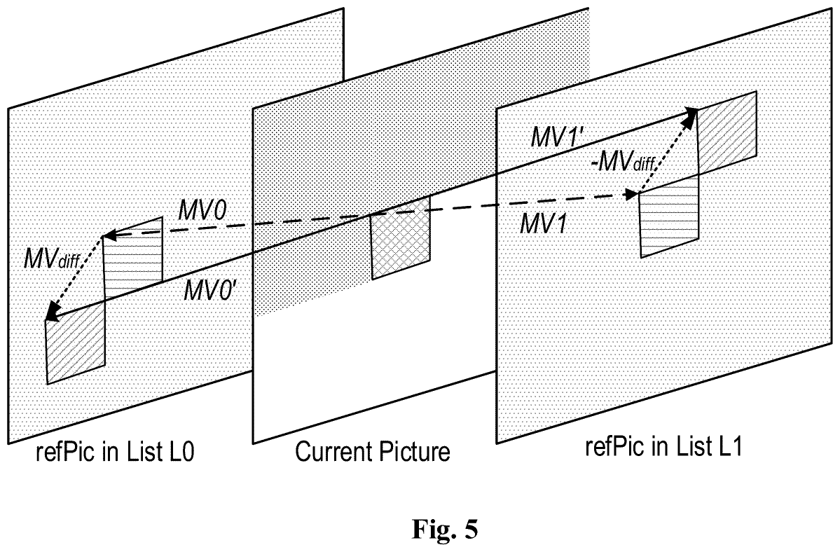

In order to increase the accuracy of the MVs of the merge mode, a bilateral-matching (BM) based decoder side motion vector refinement is applied in VVC. In bi-prediction operation, a refined MV is searched around the initial MVs in the reference picture list L0 and reference picture list L1. The BM method calculates the distortion between the two candidate blocks in the reference picture list L0 and list L1. As illustrated in FIG. 5, the SAD between the red blocks based on each MV candidate around the initial MV is calculated. The MV candidate with the lowest SAD becomes the refined MV and used to generate the bi-predicted signal.

In VVC, the application of DMVR is restricted and is only applied for the CUs which are coded with following modes and features:
CU level merge mode with bi-prediction MV.
One reference picture is in the past and another reference picture is in the future with respect to the current picture.
The distances (i.e., POC difference) from two reference pictures to the current picture are same.
Both reference pictures are short-term reference pictures.
CU has more than 64 luma samples.
Both CU height and CU width are larger than or equal to 8 luma samples.
BCW weight index indicates equal weight.
WP is not enabled for the current block.
CIIP mode is not used for the current block.

The refined MV derived by DMVR process is used to generate the inter prediction samples and also used in temporal motion vector prediction for future pictures coding. While the original MV is used in deblocking process and also used in spatial motion vector prediction for future CU coding.

The additional features of DMVR are mentioned in the following sub-clauses.

In DVMR, the search points are surrounding the initial MV and the MV offset obey the MV difference mirroring rule. In other words, any points that are checked by DMVR, denoted by candidate MV pair (MV0, MV1) obey the following two equations.

$$MV {0}^{′} = MV 0 + MV\_offset$$

$$MV {1}^{′} = MV 1 - MV\_offset$$

Where MV_offset represents the refinement offset between the initial MV and the refined MV in one of the reference pictures. The refinement search range is two integer luma samples from the initial MV. The searching includes the integer sample offset search stage and fractional sample refinement stage.

25 points full search is applied for integer sample offset searching. The SAD of the initial MV pair is first calculated. If the SAD of the initial MV pair is smaller than a threshold, the integer sample stage of DMVR is terminated. Otherwise SADs of the remaining 24 points are calculated and checked in raster scanning order. The point with the smallest SAD is selected as the output of integer sample offset searching stage. To reduce the penalty of the uncertainty of DMVR refinement, it is proposed to favor the original MV during the DMVR process. The SAD between the reference blocks referred by the initial MV candidates is decreased by ¼ of the SAD value.

The integer sample search is followed by fractional sample refinement. To save the calculational complexity, the fractional sample refinement is derived by using parametric error surface equation, instead of additional search with SAD comparison. The fractional sample refinement is conditionally invoked based on the output of the integer sample search stage. When the integer sample search stage is terminated with center having the smallest SAD in either the first iteration or the second iteration search, the fractional sample refinement is further applied.

In parametric error surface based sub-pixel offsets estimation, the center position cost and the costs at four neighboring positions from the center are used to fit a 2-D parabolic error surface equation of the following form

$$E ( x , y ) = {A ( x - {x}_{min} )}^{2} + {B ( y - {y}_{min} )}^{2} + C$$

where (xₘᵢₙ, yₘᵢₙ) corresponds to the fractional position with the least cost and C corresponds to the minimum cost value. By solving the above equations by using the cost value of the five search points, the (xₘᵢₙ, yₘᵢₙ) is computed as:

$${x}_{min} = ( E ( - 1 , 0 ) - E ( 1 , 0 ) ) / ( 2 ( E ( - 1 , 0 ) + E ( 1 , 0 ) - 2 E ( 0 , 0 ) ) )$$

$${y}_{min} = ( E ( 0 , - 1 ) - E ( 0 , 1 ) ) / ( 2 ( ( E ( 0 , - 1 ) + E ( 0 , 1 ) - 2 E ( 0 , 0 ) ) )$$

The value of xₘᵢₙ and yₘᵢₙ are automatically constrained to be between −8 and 8 since all cost values are positive and the smallest value is E(0,0). This corresponds to half peal offset with 1/16th-pel MV accuracy in VVC. The computed fractional (xₘᵢₙ, yₘᵢₙ) are added to the integer distance refinement MV to get the sub-pixel accurate refinement delta MV.

In VVC, the resolution of the MVs is 1/16 luma samples. The samples at the fractional position are interpolated using a 8-tap interpolation filter. In DMVR, the search points are surrounding the initial fractional-pel MV with integer sample offset, therefore the samples of those fractional position need to be interpolated for DMVR search process. To reduce the calculation complexity, the bi-linear interpolation filter is used to generate the fractional samples for the searching process in DMVR. Another important effect is that by using bi-linear filter is that with 2-sample search range, the DVMR does not access more reference samples compared to the normal motion compensation process. After the refined MV is attained with DMVR search process, the normal 8-tap interpolation filter is applied to generate the final prediction. In order to not access more reference samples to normal MC process, the samples, which is not needed for the interpolation process based on the original MV but is needed for the interpolation process based on the refined MV, will be padded from those available samples. When the width and/or height of a CU are larger than 16 luma samples, it will be further split into subblocks with width and/or height equal to 16 luma samples. The maximum unit size for DMVR searching process is limit to 16×16.

### 2.3. Multi-Pass Decoder-Side Motion Vector Refinement (ECM)

A multi-pass decoder-side motion vector refinement is applied. In the first pass, bilateral matching (BM) is applied to the coding block. In the second pass, BM is applied to each 16×16 subblock within the coding block. In the third pass, MV in each 8×8 subblock is refined by applying bi-directional optical flow (BDOF). The refined MVs are stored for both spatial and temporal motion vector prediction.

### 2.3.1 First Pass—Block Based Bilateral Matching MV Refinement

In the first pass, a refined MV is derived by applying BM to a coding block. Similar to decoder-side motion vector refinement (DMVR), in bi-prediction operation, a refined MV is searched around the two initial MVs (MV0 and MV1) in the reference picture lists L0 and L1. The refined MVs (MV0_pass1 and MV1_pass1) are derived around the initiate MVs based on the minimum bilateral matching cost between the two reference blocks in L0 and L1.

BM performs local search to derive integer sample precision intDeltaMV. The local search applies a 3×3 square search pattern to loop through the search range [−sHor, sHor] in horizontal direction and [−sVer, sVer] in vertical direction, wherein, the values of sHor and sVer are determined by the block dimension, and the maximum value of sHor and sVer is 8.

The bilateral matching cost is calculated as: bilCost=mvDistanceCost+sadCost. When the block size cbW* cbH is greater than 64, mean-removal SAD (MRSAD) cost function is applied to remove the DC effect of distortion between reference blocks. When the bilCost at the center point of the 3×3 search pattern has the minimum cost, the intDeltaMV local search is terminated. Otherwise, the current minimum cost search point becomes the new center point of the 3×3 search pattern and continue to search for the minimum cost, until it reaches the end of the search range.

The existing fractional sample refinement is further applied to derive the final deltaMV. The refined MVs after the first pass is then derived as:

$$MV0\_pass1 = MV0 + deItaMV ,$$

$$MV1\_pass1 = MV 1 - deItaMV .$$

### 2.3.2 Second Pass—Subblock Based Bilateral Matching MV Refinement

In the second pass, a refined MV is derived by applying BM to a 16×16 grid subblock. For each subblock, a refined MV is searched around the two MVs (MV0_pass1 and MV1_pass1), obtained on the first pass, in the reference picture list L0 and L1. The refined MVs (MV0_pass2(sbIdx2) and MV1_pass2(sbIdx2)) are derived based on the minimum bilateral matching cost between the two reference subblocks in L0 and L1.

For each subblock, BM performs full search to derive integer sample precision intDeltaMV. The full search has a search range [−sHor, sHor] in horizontal direction and [−sVer, sVer] in vertical direction, wherein, the values of sHor and sVer are determined by the block dimension, and the maximum value of sHor and sVer is 8.

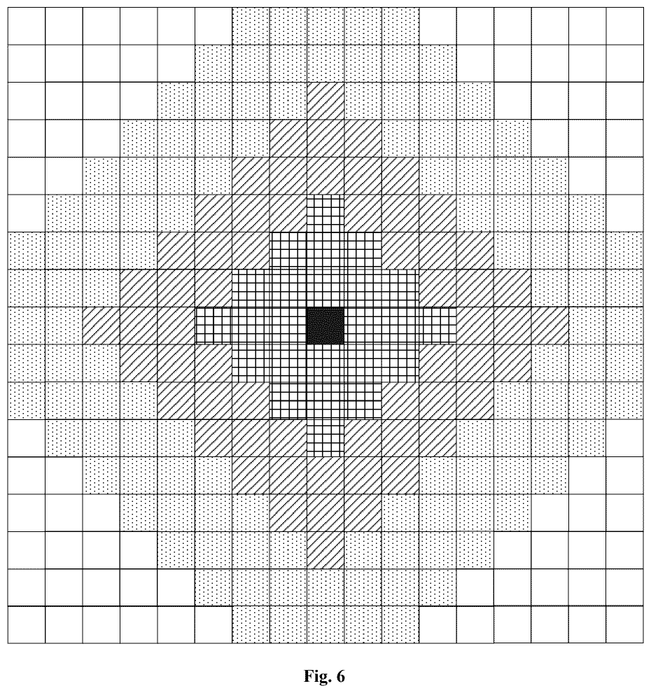

The bilateral matching cost is calculated by applying a cost factor to the SATD cost between two reference subblocks, as: bilCost=satdCost*costFactor. The search area (2*sHor+1)*(2*sVer+1) is divided up to 5 diamond shape search regions shown on FIG. 6. Each search region is assigned a costFactor, which is determined by the distance (intDeltaMV) between each search point and the starting MV, and each diamond region is processed in the order starting from the center of the search area. In each region, the search points are processed in the raster scan order starting from the top left going to the bottom right corner of the region. When the minimum bilCost within the current search region is less than a threshold equal to sbW*sbH, the int-pel full search is terminated, otherwise, the int-pel full search continues to the next search region until all search points are examined. Additionally, if the difference between the previous minimum cost and the current minimum cost in the iteration is less than a threshold that is equal to the area of the block, the search process terminates.

The existing VVC DMVR fractional sample refinement is further applied to derive the final deltaMV (sbIdx2). The refined MVs at second pass is then derived as:

$$MV0\_pass2 ( sbIdx 2 ) = MV0\_pass1 + deltaMV ( sbIdx 2 )$$

$$MV1\_pass2 ( sbIdx 2 ) = MV1\_pass1 - deltaMV ( sbIdx 2 ) .$$

### 2.3.3 Third Pass—Subblock Based Bi-Directional Optical Flow MV Refinement

In the third pass, a refined MV is derived by applying BDOF to an 8×8 grid subblock. For each 8×8 subblock, BDOF refinement is applied to derive scaled Vx and Vy without clipping starting from the refined MV of the parent subblock of the second pass. The derived bioMv (Vx, Vy) is rounded to 1/16 sample precision and clipped between −32 and 32.

The refined MVs (MV0_pass3 (sbIdx3) and MV1_pass3 (sbIdx3)) at third pass are derived as:

$$MV0\_pass3 ( sbIdx 3 ) = MV0\_pass2 ( sbIdx 2 ) + bioMv ,$$

$$MV1\_pass3 ( sbIdx 3 ) = MV0\_pass2 ( sbIdx 2 ) - bioMv .$$

In all aforementioned sub-clauses, when wrap around motion compensation is enabled, the motion vectors shall be clipped with wrap around offset taken into consideration.

### 2.3.4 Adaptive Decoder-Side Motion Vector Refinement

Adaptive decoder side motion vector refinement method is an extension of multi-pass DMVR which consists of the two new merge modes to refine MV only in one direction, either L0 or L1, of the bi prediction for the merge candidates that meet the DMVR conditions. The multi-pass DMVR process is applied for the selected merge candidate to refine the motion vectors, however either MVD0 or MVD1 is set to zero in the 1^{st} pass (i.e., PU level) DMVR.

The merge candidates for the new merge mode are derived from spatial neighboring coded blocks, TMVPs, non-adjacent blocks, HMVPs, pair-wise candidate, similar as in the regular merge mode. The difference is that only those meet DMVR conditions are added into the candidate list. The same merge candidate list is used by the two new merge modes. If the list of BM candidates contains the inherited BCW weights and DMVR process is unchanged except the computation of the distortion is made using MRSAD or MRSATD if the weights are non-equal and the bi-prediction is weighted with BCW weights. Merge index is coded as in regular merge mode.

### 3. Problems

There are several parts in the BDOF MV refinement/sample adjustment may be improved.
The current formulas which is used to drive BDOF parameters, are not accurate formulas.
There are no weights to indicate the importance of each sample in the final formula.
There is no filtering process to smooth out the final derived MV refinement/sample adjustment.
There is no clear distinction for conditions of applying BDOF for MV refinement/sample adjustment.

Similarly, no distinction for their formula.

### 4. Detailed Solutions

The detailed solutions below should be considered as examples to explain general concepts. These solutions should not be interpreted in a narrow way. Furthermore, these solutions can be combined in any manner.

The methods disclosed below may be applied to bi-directional optical flow, decoder side motion vector refinement, and any extensions of them.

### On BDOF MV Refinement Parameter Derivation

In the following section general equation for deriving BDOF parameters (vx and vy) is defined as:

$$\sum Gx . Gx * vx + \sum Gx . Gy * vy = \sum dI \cdot Gx . \to s 1 * vx + s 2 * vy = s 3 ,$$

$$\sum Gx . Gy * vx + \sum Gy . Gy * vy = \sum dI \cdot Gx \to s 2 * vx + s 5 * vy = s 6 ,$$

where, Gx and Gy represents summation of horizontal and vertical gradients for 2 reference pictures, respectively. dI represents the difference between 2 reference pictures. Summations (Σ) are inside of the predefined area, which could be an N×M block around current sample (for sample adjustment BDOF), or around the current prediction subblock (for MV refinement BDOF).
1. It is proposed that a method of deriving gradients different to that of BDOF in VVC may be used to calculate horizontal and/or vertical gradients.
   a. In one example gradients are computed by directly calculating the difference between two neighboring samples, i.e.,

$$\frac{\partial {I}^{( k )}}{\partial x} ( i , j ) = ( ( {I}^{( k )} ( i + 1 , j ) ≫ 1 ) - ( {I}^{( k )} ( i - 1 , j ) ≫ 1 ) )$$

$$\frac{\partial {I}^{( k )}}{\partial y} ( i , j ) = ( ( {I}^{( k )} ( i , j + 1 ) ≫ 1 ) - ( {I}^{( k )} ( i , j - 1 ) ≫ 1 ) )$$

b. In another example gradients are computed by calculating the difference between two shifted neighboring samples, i.e.,

$$\frac{\partial {I}^{( k )}}{\partial x} ( i , j ) = ( ( {I}^{( k )} ( i + 1 , j ) ≫ shift 1 ) - ( {I}^{( k )} ( i - 1 , j ) ≫ shift 1 ) )$$

$$\frac{\partial {I}^{( k )}}{\partial y} ( i , j ) = ( ( {I}^{( k )} ( i , j + 1 ) ≫ shift 2 ) - ( {I}^{( k )} ( i , j - 1 ) ≫ shift 2 ) )$$

i. shift1 and shift2 may be any integers such as 0, 1, 2, 6, . . . or even negative integers.
c. In another example gradients may be calculated with Nb samples before and Na samples after current samples as a weighted sum:

$$\frac{\partial {I}^{( k )}}{\partial x} ( i , j ) = {\sum }_{p = - Nb}^{Na} wp * {I}^{( k )} ( i + p , j )$$

$$\frac{\partial {I}^{( k )}}{\partial y} ( i , j ) = {\sum }_{p = - Nb}^{Na} wp * {I}^{( k )} ( i , j + p )$$

i. Weights, i.e., wp, may be any integer number such as −6, 0, 2, 7 . . . or any real number such as −6.3, −0.77, 0.1, 3.0, . . .
ii. Weights for calculating horizontal and vertical gradients may be different from each other.
   (i) Alternatively, the weights for calculating horizontal and vertical gradients may be the same.
iii. Weights may be signaled from an encoder to a decoder.
iv. Weights may be derived using information decoded.
v. Nb and Na may be any integer numbers such as 0, 3, 10, . . .
vi. Nb and Na may be different for calculating gradients for horizontal and vertical directions.
   (i) Alternatively, they may be the same for calculating gradients for both horizontal and vertical directions.
2. It is proposed that a complete linear equation formula may be used to derive the final MV refinement.
   a. In one example after calculating all the gradients, s1, s2, s3, s5, and s6 are calculated as explained above:

$$\sum Gx . Gx * vx + \sum Gx . Gy * vy = \sum dI \cdot Gx . \to s 1 * vx + s 2 * vy = s 3 ,$$

$$\sum Gx . Gy * vx + \sum Gy . Gy * vy = \sum dI \cdot Gx \to s 2 * vx + s 5 * vy = s 6.$$

i. In one example, to derive the final MV of a M*N block, samples in a (M+K1)*(N+K2) region around the original block may be involved. For example, K1 and K2 may be any integer numbers such as 0, 2, 4, 7, 10, . . .
b. In one example after calculating all the s1, s2, s3, s5, and s6, the determinate values, D, Dx, and Dy are calculated as:

$$D = ( s 1 ≫ shTem ) * ( s 5 ≫ shTem ) - ( s 2 ≫ shTem ) * ( s 2 ≫ shTem ) ,$$

$$Dx = ( s 3 ≫ shTem ) * ( s 5 ≫ shTem ) - ( s 6 ≫ shTem ) * ( s 2 ≫ shTem ) ,$$

$$Dy = ( s 1 ≫ shTem ) * ( s 6 ≫ shTem ) - ( s 3 ≫ shTem ) * ( s 2 ≫ shTem ) .$$

i. In one example shTem maybe any integer number such as 0, 1, 3, . . .
c. In one example after calculating D, Dx, and Dy; vx and vy may be derived as:

$$vx = Dx / D and vy = Dy / D .$$

i. In another example if abs (D) is smaller than a predefined threshold, C, vx and vy are set to zero. C may be any non-negative number such as 0, 10, 17, . . .
d. In one example any amount of the shifts and clipping may be involved to derive the final vx and vy.
   i. In one example the numerator and/or denominator, may have an extra shift, in a way that overall, it is left shifted by K so that the final derived vx and vy have higher precision. K may be any integer number such as 0, 1, 3, 4, 6, . . .
   ii. In one example these shifts may come in any order, such as having the shifts at the beginning, and/or having the shift for intermediate variables and/or having the shift on the final MVs.
   iii. In one example the final vx and vy may be clipped between −B and B, where B may be any integer number such as 2, 10, 17, 32, 100, 156, 725, . . .
e. In one example the final vx and vy may be multiplied (or similarly divided) by a number before getting used for motion compensation procedure.
   i. In one example vx and vy may be multiplied by R, where R is any real number, such as 1.25, 2, 3.1, 4, . . .
   ii. In another example vx and vy may be divided by R, where R is any real number, such as 1.25, 2, 3.1, 4, . . .
   iii. In one example the value of the number to multiply (or divide) the final vx, vy with may be different for vx and vy.
   iv. In one example the value of the number to multiply (or divide) the final vx, vy, may depend on the block size, sequence resolution, block characteristics, and so on.
3. It is proposed that a partial linear equation solution may be used to derive the final MV refinement.
   a. In one example after calculating all the gradients, s1, s2, s3, s5, and s6 are calculated as explained above:

$$\sum Gx . Gx * vx + \sum Gx . Gy * vy = \sum dI \cdot Gx . \to s 1 * vx + s 2 * vy = s 3 ,$$

$$\sum Gx . Gy * vx + \sum Gy . Gy * vy = \sum dI \cdot Gx \to s 2 * vx + s 5 * vy = s 6.$$

b. In one example after calculating all the s1, s2, s3, s5, and s6, approximated version of vx and vy may be calculated as:

$$vx = s 3 / s 1 ,$$

$$vy = ( s 6 - s2 * vx ) / s 5 .$$

c. In another example after calculating vx similar to above, partial amount of the vx may be put in the second formula to derive the vy.
   i. In one example vy may be derived as vy=(s6−s2*vx/T)/s5, where T may be any real number such as 1.1, 2, 4, . . .
d. In one example after calculating all the s1, s2, s3, s5, and s6, approximated version of vx and vy may be calculated as:

Assume vx is zero: vy=s6/s5,

Insert vy in the first formula: vx=(s3−s2*vy)/s1.
e. In another example after calculating vy similar to above, partial amount of the vy may be inserted in the second formula to derive the vx.
   i. In one example vx may be derived as vx=(s3−s2*vy/T)/s1, where T may be any real number such as 1.1, 2, 4, . . .
f. In one example after calculating all the s1, s2, s3, s5, and s6, approximated version of vx and vy may be calculated as:

Assume vy is zero: vx=s3/s1.

Assume vx is zero: vy=s6/s5.
4. It is proposed that a simplified solution may be used to derive the final MV refinement.
   a. In one example the method explained in the background section for VVC BDOF may be used to derive the approximated version of s1, s2, s3, s5, and s6.
   b. In one example after calculating approximated version of the s1, s2, s3, s5, and s6, the determinate values, D, Dx, and Dy are calculated as:

$$D = ( s 1 ≫ shTem ) * ( s 5 ≫ shTem ) - ( s 2 ≫ shTem ) * ( s 2 ≫ shTem ) ,$$

$$Dx = ( s 3 ≫ shTem ) * ( s 5 ≫ shTem ) - ( s 6 ≫ shTem ) * ( s 2 ≫ shTem ) ,$$

$$Dy = ( s 1 ≫ shTem ) * ( s 6 ≫ shTem ) - ( s 3 ≫ shTem ) * ( s 2 ≫ shTem ) .$$

i. In one example after calculating D, Dx, and Dy; vx and vy may be derived as: vx=Dx/D and vy=Dy/D.
ii. In one example shTem maybe any integer number such as 0, 1, 3, . . .
c. In one example after calculating approximated version of the s1, s2, s3, s5, and s6, approximated version of vx and vy may be calculated as:

Assume vy is zero: vx=s3/s1,

Substitute vx in the second formula: vy=(s6−s2*vx)/s5.
i. Or alternatively, a modified vx may be inserted in the second formula: vy=(s6−s2*vx/T)/s5, where T may be any real number such as 1.1, 2, 4, . . .
ii. Alternatively, first vx may be assumed zero, and vy may be derived, after that either vy or a scaled version of it may be inserted into the first equation and vx may be derived.
5. It is proposed any combination of the methods explained above may be used to derive the final MV refinement.
   a. In one example any combination of the methods explained above (2, 3, and 4) may be combined and used together.

### On BDOF Sample Adjustment Parameter Derivation

6. It is proposed that any of the method explained above for BDOF MV refinement may also be used for BDOF sample adjustment parameter derivation.
   a. In one example after calculating all the gradients, s1, s2, s3, s5, and s6 are calculated as explained above:

$$Σ Gx . Gx * vx + Σ Gx . Gy * vy = Σ dI . Gx . \to s 1 * vx + s 2 * vy = s 3 ,$$

$$Σ Gx . Gy * vx + Σ Gy . Gy * vy = Σ dI . Gy \to s 2 * vx + s 5 * vy = s 6 .$$

i. In one example samples in a K×K region around the sample may be involved in the derivation. K may be any integer number such as 1, 3, 4, 5, 7, 10, . . .
b. In one example after calculating s1, s2, s3, s5, and s6, the determinate values, D, Dx, and Dy are calculated as:

$$D = ( s 1 >> shTem ) * ( s 5 >> shTem ) - ( s 2 >> shTem ) * ( s 2 >> shTem ) ,$$

$$Dx = ( s 3 >> shTem ) * ( s 5 >> shTem ) - ( s 6 >> shTem ) * ( s 2 >> shTem ) ,$$

$$Dy = ( s 1 >> shTem ) * ( s 6 >> shTem ) - ( s 3 >> shTem ) * ( s 2 >> shTem ) .$$

i. shTem maybe any integer number such as 0, 1, 3, . . .
ii. In one example after calculating D, Dx, and Dy; vx and vy may be derived as:

$$vx = Dx / D and vy = Dy / D .$$

iii. In another example if abs(D) is smaller than a predefined threshold, C, vx and vy are set to zero. C may be any non-negative number such as 0, 10, 17, . . .
c. In one example after calculating s1, s2, s3, s5, and s6, approximated version of vx and vy may be calculated as:

$$v x = s 3 / s 1 ,$$

$$vy = ( s 6 - s 2 * vx ) / s 5.$$

i. Or alternatively a modified vx may be put in the second formula: vy=(s6−s2*vx/T)/s5, where T may be any real number such as 1.1, 2, 4, . . .
ii. Alternatively, first vx may be assumed zero, and vy may be derived, after that either vy or a scaled version of it may be substituted into the first equation and vx may be derived.
d. In one example the method explained in the background section for VVC BDOF may be used to derive the approximated version of s1, s2, s3, s5, and s6.
e. In one example the final vx and vy may be multiplied (or divided or shifted) by a number before getting used for sample adjustment procedure.
   i. In one example vx and vy may be multiplied by R, where R is any real number, such as 1.25, 2, 3.1, 4, . . .
   ii. In another example vx and vy may be divided by R, where R is any real number, such as 1.25, 2, 3.1, 4, . . .
   iii. In one example the value of the number to multiply (or divide) the final vx, vy with may be different for vx and vy.
   iv. In one example the value of the number to multiply (or divide) the final vx, vy, may depend on the block size, sequence resolution, block characteristics, position in the block, and so on.

### On Applying Weights in Parameter Derivation

7. It is proposed that any weights may be applied before adding BDOF intermediate parameters for MV refinement.
   a. In one example during adding parameters to get s1, s2, s3, s5, and s6, inside of the target region of Ω (a M_ext*N_ext region around the current block), all the values are added with similar weight (of 1).
   b. In another example during adding parameters to get s1, s2, s3, s5, and s6, inside of the target region of Ω (a M_ext*N_ext region around the current block), the values are added after being multiplied with a predefined weight depending on their position in the extended block (target region of Ω).
   c. In one example these predefined weights are defined as:

$$w = ( x >= ( width / 2 ) ? width - x : x + 1 ) * ( y >= ( height / 2 ) ? height - y : y + 1 )$$

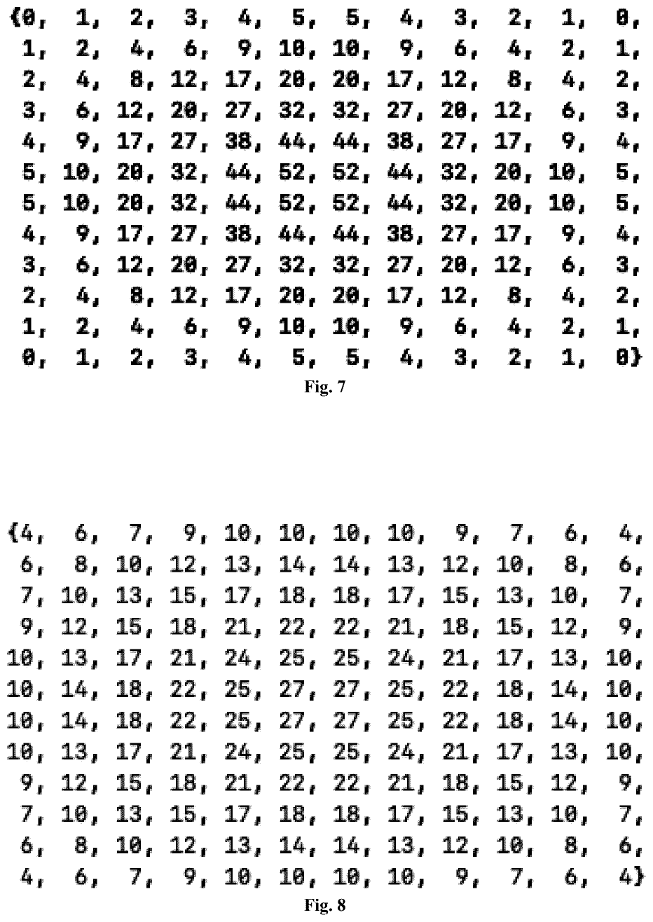

for x from 0 to width −1 and y from 0 to height −1.
Width and height represent the width and height of the target region.
d. In another example these predefined weights may be generated with some known probability distribution such as Gaussian distribution with any value of the standard deviations (σ=1, 1.5, 4, or any other real number) and center position.
   i. In one example these weights are generated with Gaussian distribution with σ=2.5 for a 12×12 region as depicted in FIG. 7.
   ii. In one example these weights are generated with Gaussian distribution with σ=4 for a 12×12 region as depicted in FIG. 8.
e. In another example during adding parameters to get s1, s2, s3, s5, and s6, inside of the target region of Ω (a M_ext*N_ext region around the current block), the values are added after being shifted with a predefined values depending on their position in the extended block (target region of Ω).
f. In one example the weight matrix may be represented as left (or right) shift matrix, and depending on the matrix entries, the data gets shifted (left or right) before summation.
8. In one example depending on the block size, block shape, block characteristics, sequence resolutions, and so, different weights may be applied.
   i. Or alternatively depending on the block size, block shape, block characteristics, sequence resolutions, and so on, no weight may be applied.
   ii. The weight matrix may be coded explicitly in sequence parameter set (SPS), picture parameter set (PPS), or slice header (SH).
9. It is proposed that any weights may be applied before adding BDOF intermediate parameters for sample adjustment.
   a. In one example during adding parameters to get s1, s2, s3, s5, and s6, inside of the target region of Ω (a K1*K2 region around the current sample), all the values are added with similar weight (of 1). K1 and K2 may be any integer number such as 1, 2, 3, 5, 8, . . .
   b. In another example during adding parameters to get s1, s2, s3, s5, and s6, inside of the target region of Ω (a K1*K2 region around the current sample), the values are added after being multiplied with a predefined weight depending on their position in the extended block (target region of Ω).
   c. In one example these predefined weights are defined as:

$$w = ( x >= ( K 1 / 2 ) ? K 1 - x : x + 1 ) * ( y >= ( K 2 / 2 ) ? K 2 - y : y + 1 ) ,$$

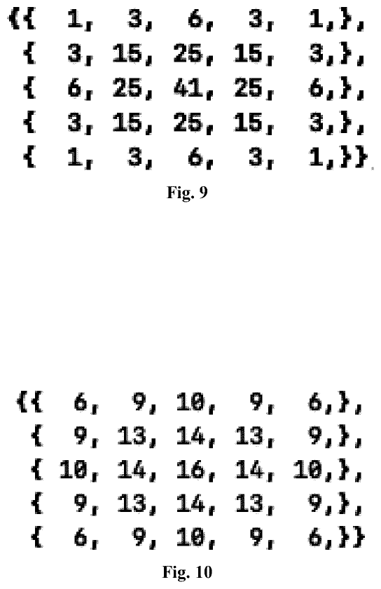

for x from 0 to K1−1 and y from 0 to K2−1.
K1 and K2 represent the width and height of the target region.
d. In another example these predefined weights may be generated with some known probability distribution such as Gaussian distribution with any value of the standard deviations (σ=1, 1.5, 2, 4, or any other real number) and any center position.
   i. In one example these weights are generated with Gaussian distribution with σ=1 for a 5×5 region as depicted in FIG. 9.
   ii. In one example these weights are generated with Gaussian distribution with σ=2 for a 5×5 region as depicted in FIG. 10.
e. In one example the weight matrix may be represented as a left (or right) shift matrix, and depending on the matrix entries, the data gets shifted (left or right) before summation.
f. In one example depending on the block size, block shape, block characteristics, sequence resolutions, and so, different weights may be applied.
   i. Or alternatively depending on the block size, block shape, block characteristics, sequence resolutions, and so on, no weight may be applied.

### On Applying Filters on the Final MV Refinement or Sample Adjustment

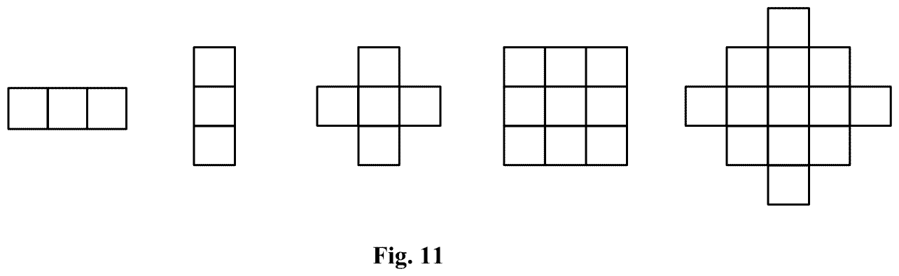

10. It is proposed that any type of the filters may be applied on the final derived MV refinement (vx and vy). Some examples are depicted in FIG. 11.
   a. In one example any smoothing filter of any shape may be applied on all the MVs derived by BDOF for each subblock.
   b. In one example during filter application all the MVs inside of the PU may be used.
   c. In another example during filter application, only MVs with similar 2^{nd} round of DMVR MVs, may be used for those MVs.
   d. In one example a shape filter with any weights may be applied on the MVs.
      i. In one stance the weight for the center may be 8, and the weight for 4 sides may be 1.
      ii. In one stance the weight for the center may be 4, and the weight for 4 sides may be 1.
      iii. In one stance the weight for the center may be 4, and the weight for 4 sides may be 2.
      iv. In one stance the weight for the center may be 4, and the weight for 4 sides may be 3.
      v. In one stance the weight for the center may be 1, and the weight for 4 sides may be 1.
11. It is proposed that any type of the filters may be applied on the final derived BDOF sample MV adjustment, or final sample adjustment. Some examples are depicted in FIG. 11.
   a. In one example filter is applied on all (vx,vy) s or final adjustment inside of the subblock.
   b. In one example, a shape filter with any weights may be applied on the (vx,vy) s or final adjustment.
      i. In one stance the weight for the center may be 8, and the weight for 4 sides may be 1.
      ii. In one stance the weight for the center may be 4, and the weight for 4 sides may be 1.
      iii. In one stance the weight for the center may be 4, and the weight for 4 sides may be 2.
      iv. In one stance the weight for the center may be 4, and the weight for 4 sides may be 3.
      v. In one stance the weight for the center may be 1, and the weight for 4 sides may be 1.

### On conditions for Applying BDOF

12. It is proposed that there may be a condition on applying BDOF MV refinement or BDOF sample adjustment.
   a. In one example the condition of applying BDOF MV refinement may be similar to the condition of applying BDOF sample adjustment.
   b. In another example, the condition of applying BDOF MV refinement may be different of the condition of applying BDOF sample adjustment. For example, BDOF MV refinement may be applied to bi-prediction coded CU with un-equal weight, while BDOF sample adjustment may only be applied to bi-prediction coded CU with equal weight.
13. It is proposed that the cost for evaluating the BDOF condition may depend on a cost between 2 reference picture blocks.
   a. In one example different cost functions may be used to derive the cost.
      i. In one example this cost may be Sum of Absolute Difference (SAD) between the 2 reference picture blocks.
      ii. In one example this cost may be Sum of Absolute Transformed Difference (SATD) or any other cost measure between the 2 reference picture blocks.
      iii. In one example this cost may be Mean Removal based Sum of Absolute Difference (MR-SAD) between the 2 reference picture blocks.
      iv. In one example this cost may be a weighted average of SAD/MR-SAD and SATD between the 2 reference picture blocks.
      v. In one example, the cost function between 2 reference picture blocks may be:
         (i) Sum of absolute differences (SAD)/mean-removal SAD (MR-SAD);
         (ii) Sum of absolute transformed differences (SATD)/mean-removal SATD (MR-SATD);
         (iii) Sum of squared differences (SSD)/mean-removal SSD (MR-SSD);
         (iv) SSE/MR-SSE;
         (v) Weighted SAD/weighted MR-SAD;
         (vi) Weighted SATD/weighted MR-SATD;
         (vii) Weighted SSD/weighted MR-SSD;
         (viii) Weighted SSE/weighted MR-SSE;
         (ix) Gradient information.

### On BDOF MV Refinement Subblock Size

14. It is proposed any subblock size, depending on the conditions, may be used as BDOF MV refinement subblock size.
   a. In one example subblock size may be a fixed size such as N×M, where N and M could be any positive integer, such as 1, 2, 3, 4, 5, 8, 12, 32, . . .
   b. In another example subblock size may depend on the current PU, or CU size. As an example, for block size W×H, subblock size of W1×H1 may be used, where W1 and H1 depend on W and H, and could be any positive integer number.
   c. In one example subblock size may depend on the reference pictures characteristics.
      i. In one example, subblock size may be determined by the similarity of two predictors from two reference pictures. If two predictors are similar, such as SAD between these two predictors is small, the larger subblock size may be applied; Otherwise, the small subblock size may be applied.
      ii. In one example, subblock size may be determined by the distribution of the difference between two predictors. Those subblocks with difference energy, such as SAD or SSE, may be merged to a larger unit for MV refinement to reduce the computation complexity.
   d. In one example subblock size may depend on the temporal gradient of the 2 reference blocks.
      i. In one example any cost function such as SAD, may be used for calculating the 2 reference block gradients (or differences).
   e. In one example the spatial gradients of the reference blocks may be used to determine the subblock size.
   f. In one example the subblock size may depend on the prediction type.
   g. In one example the subblock size my depend on the DMVR first and/or 2^{nd} stage adjustment value.
   h. In one example the subblock size may depend on the sequence resolution.
   i. In one example the subblock size may be a function of all or some of the parameters mentioned above.

### General Aspects

15. In one example, the division operation disclosed in the document may be replaced by non-division operations, which may share the same or similar logic to the division-replacement logic in CCLM or CCCM.
16. Whether to and/or how to apply the methods described above may be dependent on coded information.
   a. In one example, the coded information may include block sizes and/or temporal layers, and/or slice/picture types, colour component, et al.
17. Whether to and/or how to apply the methods described above may be indicated in the bitstream.
   a. The indication of enabling/disabling or which method to be applied may be signalled at sequence level/group of pictures level/picture level/slice level/tile group level, such as in sequence header/picture header/SPS/VPS/DPS/DCI/PPS/APS/slice header/tile group header.
   b. The indication of enabling/disabling or which method to be applied may be signaled at PB/TB/CB/PU/TU/CU/VPDU/CTU/CTU row/slice/tile/sub-picture/other kinds of region contain more than one sample or pixel.

More details of the embodiments of the present disclosure will be described below which are related to a bi-directional optical flow (BDOF) process. The embodiments of the present disclosure should be considered as examples to explain the general concepts and should not be interpreted in a narrow way. Furthermore, these embodiments can be applied individually or combined in any manner.

As used herein, the term “block” may represent a color component, a sub-picture, a picture, a slice, a tile, a coding tree unit (CTU), a CTU row, groups of CTU, a coding unit (CU), a prediction unit (PU), a transform unit (TU), a coding tree block (CTB), a coding block (CB), a prediction block (PB), a transform block (TB), a sub-block of a video block, a sub-region within a video block, a video processing unit comprising multiple samples/pixels, and/or the like. A block may be rectangular or non-rectangular.

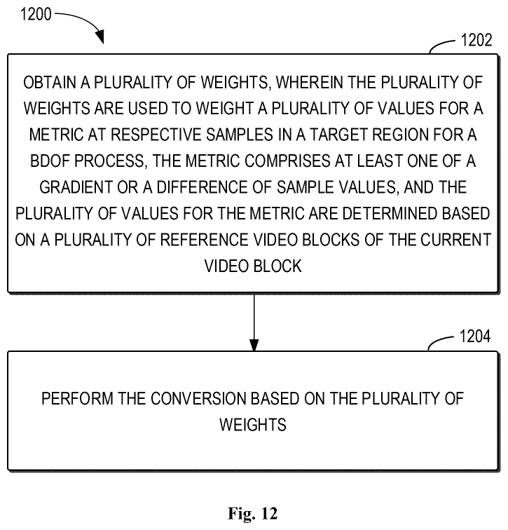

FIG. 12 illustrates a flowchart of a method 1200 for video processing in accordance with some embodiments of the present disclosure. The method 1200 may be implemented during a conversion between a current video block of a video and a bitstream of the video. As shown in FIG. 12, the method 1200 starts at 1202 where a plurality of weights are obtained. The plurality of weights are used to weight a plurality of values for a metric at respective samples in a target region for a BDOF process applied on the current video block. The metric comprises at least one of a gradient or a difference of sample values. Furthermore, the plurality of values for the metric are determined based on a plurality of reference video blocks of the current video block.

At 1204, the conversion is performed based on the plurality of weights. By way of example rather than limitation, a set of parameters for the BDOF process may be determined based on the plurality of weights. Furthermore, at least one offset may be determined based on the set of parameters.

In some embodiments, the at least one offset may be used for refining a motion vector (MV) of the current video block. In this case, the at least one offset may also be referred to as MV refinement. If a size of the current video block is M×N, the target region may comprise a region around the current video block of a size (M+K1)×(N+K2). Each of M, N, K1 and K2 may be an integer, such as 0, 2, 4, 7, 10, or the like.

In some alternative embodiments, the at least one offset may be used for adjusting a current sample in the current video block. In this case, the BDOF process is also referred to as sample-based BDOF. The target region may comprise a region around the current sample with a size of K3×K4. Each of K3 and K4 may be an integer, such as 1, 3, 4, 5, 7, 10, or the like.

Moreover, the conversion may be performed based on the at least one offset. In some embodiments, the conversion may include encoding the current video block into the bitstream.

Alternatively or additionally, the conversion may include decoding the current video block from the bitstream. It should be understood that the above illustrations and/or examples are described merely for purpose of description. The scope of the present disclosure is not limited in this respect.

In view of the above, a plurality of weights are used to weight a plurality of values for the metric at respective samples in a target region for the BDOF process. Compared with the conventional solution where no weight is used, in aid of the plurality of weights, the proposed method can advantageously determine one or more parameter for the BDOF process by taking the importance of samples in the target region into consideration. Thereby, the coding quality can be improved.

In some embodiments, the set of parameters for the BDOF process may be determined based on the plurality of weights and a complete linear equation formula. Alternatively, the set of parameters may be determined based on the plurality of weights and a partial linear equation solution or the simplified solution. This will be described in detail below.

In some embodiments, the set of parameters may comprise a first parameter, a second parameter, a third parameter, a fourth parameter, and a fifth parameter. Each of these parameters may be determined in a predetermined manner.

In some embodiments, the gradient may comprise at least one of a horizontal gradient or a vertical gradient. The set of parameters may be determined based on the following:

$$s 1 = Σ ( Gx \cdot Gx ) ,$$

$$s 2 = Σ ( Gx \cdot Gy ) ,$$

$$s 3 = Σ ( dI \cdot Gx ) ,$$

$$s 5 = Σ ( Gy \cdot Gx ) ,$$

$$s 6 = Σ ( dI \cdot Gy ) ,$$

where s1 represents the first parameter, s2 represents the second parameter, s3 represents the third parameter, s5 represents the fourth parameter, s6 represents the fifth parameter, Gx represents a summation of values for the horizontal gradient determined for each of the plurality of reference video blocks, Gy represents a summation of values for the vertical gradient determined for each of the plurality of reference video blocks, dI represents the difference of sample values between the plurality of reference video blocks, and Σ( ) represents a weighted sum inside the target region based on the plurality of weights. In this case, these five parameters s1, s2, s3, s5, and s6 are determined based on an accurate formula for BDOF. Thereby, the coding quality can be advantageously improved.

Alternatively, the set of parameters may be determined based on the following:

$$s 1 = {\sum }_{( i , j ) ∈ Ω} Abs ( {ψ}_{x} ( i , j ) ) ,$$

$$s 2 = {\sum }_{( i , j ) ∈ Ω} {ψ}_{x} ( i , j ) \cdot Sign ( {ψ}_{y} ( i , j ) ) ,$$

$$s 3 = {\sum }_{( i , j ) ∈ Ω} θ ( i , j ) \cdot Sign ( {ψ}_{x} ( i , j ) ) ,$$

$$s 4 = {\sum }_{( i , j ) ∈ Ω} Abs ( {ψ}_{y} ( i , j ) ) ,$$

$$s 5 = {\sum }_{( i , j ) ∈ Ω} θ ( i , j ) \cdot Sign ( {ψ}_{y} ( i , j ) ) ,$$

$${ψ}_{x} ( i , j ) = ( \frac{\partial {I}^{( 1 )}}{\partial x} ( i , j ) + \frac{\partial {I}^{( 0 )}}{\partial x} ( i , j ) ) >> na ,$$

$${ψ}_{y} ( i , j ) = ( \frac{\partial {I}^{( 1 )}}{\partial y} ( i , j ) + \frac{\partial {I}^{( 0 )}}{\partial y} ( i , j ) ) >> na ,$$

$$θ ( i , j ) = ( {I}^{( 1 )} ( i , j ) >> nb ) - ( {I}^{( 0 )} ( i , j ) >> nb ) ,$$

where s1 represents the first parameter, s2 represents the second parameter, s3 represents the third parameter, s5 represents the fourth parameter, s6 represents the fifth parameter, I^{(k)}(i, j) represents a sample value at coordinate (i, j) of a prediction signal of a reference video block of the current video block in a list k, k may be equal to 0 or 1,

$$\frac{\partial {I}^{( k )}}{\partial x} ( i , j )$$

represents a value for the horizontal gradient at coordinate (i, j) of a prediction signal of a reference video block of the current video block in a list k,

$$\frac{\partial {I}^{( k )}}{\partial y} ( i , j )$$

represents a value for the vertical gradient at coordinate (i,j) of a prediction signal for a reference video block of the current video block in a list k, Σ_{(i,j)∈Ω}() represents a weighted sum inside the target region Ω based on the plurality of weights, abs(z) represents an absolute value of a number z, sign (z) represent a sign of a number z, and each of na and nb may be an integer, such as 0, 2, 6, or the like.

In some embodiments, a set of determinant values is determined based on the set of parameters;. Furthermore, the at least one offset is determined based on the set of determinant values. By way of example rather than limitation, the set of determinant values may be determined based on the following:

$$D = ( s 1 >> shTem ) * ( s 5 >> shTem ) - ( s 2 >> shTem ) * ( s 2 >> shTem ) ,$$

$$Dx = ( s 3 >> shTem ) * ( s 5 >> shTem ) - ( s 6 >> shTem ) * ( s 2 >> shTem ) ,$$

$$Dy = ( s 1 >> shTem ) * ( s 6 >> shTem ) - ( s 3 >> shTem ) * ( s 2 >> shTem ) .$$

where D represents a first determinant value in the set of determinant values, Dx represents a second determinant value in the set of determinant values, Dy represents a third determinant value in the set of determinant values, s1 represents the first parameter, s2 represents the second parameter, s3 represents the third parameter, s5 represents the fourth parameter, s6 represents the fifth parameter, and shTem may be an integer, 0, 1, 3, or the like.

In some embodiments, the at least one offset may be determined based on the following:

$$vx = Dx / D ,$$

$$vy = Dy / D ,$$

where vx represents a first offset in the at least one offset, and vy represents a second offset in the at least one offset. In this case, the determined at least one offset is more accurate than the conventional solution. Thereby, the coding quality can be advantageously improved.

In some embodiments, if the absolute value of the first determinant value D is smaller than a predetermined threshold, each of the at least one offset (e.g., vx and vy) may be equal to a predetermined value, such as 0. For example, the predetermined threshold may be a non-negative number, such as 0, 10, 17, or the like.

In some embodiments, a first offset in the at least one offset may be determined based on the set of parameters. Moreover, a second offset in the at least one offset may be determined based on the first offset and the set of parameters.

In one example, the at least one offset may be determined based on the following:

$$vx = s 3 / s 1 ,$$

$$vy = ( s 6 - s 2 * vx ) / s 5 ,$$

where vx represents the first offset, vy represents the second offset, s1 represents the first parameter, s2 represents the second parameter, s3 represents the third parameter, s5 represents the fourth parameter, and s6 represents the fifth parameter. In this case, the at least one offset may be determined with lower computational complexity. Thereby, the coding efficiency can be advantageously improved.

In a further example, the first offset and the second offset may be determined based on the following:

$$vx = s 3 / s 1 ,$$

$$vy = ( s 6 - s 2 * vx / T 1 ) / s 5 ,$$

where vx represents the first offset, vy represents the second offset, s1 represents the first parameter, s2 represents the second parameter, s3 represents the third parameter, s5 represents the fourth parameter, s6 represents the fifth parameter, and T1 presents a real number, such as 1.1, 2, 4, or the like. In this case, the at least one offset may be determined with lower computational complexity. Thereby, the coding efficiency can be advantageously improved.

In some alternative embodiments, the second offset may be determined based on the set of parameters. Furthermore, the first offset may be determined based on the second offset and the set of parameters.

In one example, the first offset and the second offset may be determined based on the following:

$$v y = s 6 / s 5 ,$$

$$vx = ( s 3 - s 2 * vy ) / s 1 ,$$

where vx represents the first offset, vy represents the second offset, s1 represents the first parameter, s2 represents the second parameter, s3 represents the third parameter, s5 represents the fourth parameter, and s6 represents the fifth parameter. In this case, the at least one offset may be determined with lower computational complexity. Thereby, the coding efficiency can be advantageously improved.

In another example, the first offset and the second offset may be determined based on the following:

$$v y = s 6 / s 5 ,$$

$$vx = ( s 3 - s 2 * vy / T 2 ) / s 1 ,$$

where vx represents the first offset, vy represents the second offset, s1 represents the first parameter, s2 represents the second parameter, s3 represents the third parameter, s5 represents the fourth parameter, s6 represents the fifth parameter, and T2 presents a real number, such as 1.1, 2, 4, or the like. In this case, the at least one offset may be determined with lower computational complexity. Thereby, the coding efficiency can be advantageously improved.

In some alternative embodiments, the at least one offset may be determined based on the following:

$$vx = s 3 / s 1 ,$$

$$vy = s 6 / s 5 ,$$

where vx represents a first offset in the at least one offset, vy represents a second offset in the at least one offset, s1 represents the first parameter, s3 represents the third parameter, s5 represents the fourth parameter, and s6 represents the fifth parameter. In this case, the computational complexity of at least one offset may be further reduced. Thereby, the coding efficiency can be advantageously further improved.

In some embodiments, a shift operation or a clip operation may be used for determining the at least one offset. For example, the shift operation may be applied on at least one of a numerator or a denominator of a term in an equation for determining the at least one offset. By way of example rather than limitation, a right shift operation may be applied on the numerator of the term Dx/D, and a left shift operation may be applied on the numerator of the term Dy/D.

In some embodiments, the shift operation may comprise left shifting by a predetermined number of bits, such as 0, 1, 3, 4, 6, or the like. In some embodiments, the shift operation may be applied in a predetermined order, such as applying the shift operation at the beginning, and/or applying the shift operation on intermediate variables and/or applying the shift operation on the final output.

In some embodiments, the clip operation may be applied on the at least one offset to update the at least one offset. For example, a value of the at least one updated offset may be between a first value and a second value, e.g., an upper limit and a lower limit.

In some embodiments, the at least one offset may be adjusted with at least one scaling factor, and the conversion may be performed based on the at least one adjusted offset. In one example, a first offset in the at least one offset may be adjusted by multiplying the first offset by a first scaling factor in the at least one scaling factor, and the first scaling factor may be a real number, such as 1.25, 2, 3.1, 4, or the like. In another example, a second offset in the at least one offset may be adjusted by dividing the second offset by a second scaling factor in the at least one scaling factor, and the second scaling factor may be a real number, such as 1.25, 2, 3.1, 4, or the like.

In some embodiments, different offsets in the at least one offset may be adjusted with different scaling factors in the at least one scaling factor. For example, the at least one scaling factor may be dependent on a block size, a sequence resolution, a block characteristic, and/or the like.

In some embodiments, each of the plurality of weights may be equal to a same predetermined value. Alternatively, each of the plurality of weights may be dependent on a position of the corresponding sample in the target region. For example, a first weight of the plurality of weights that corresponds to a first sample in the target region may be dependent on a position of the first sample in the target region.

In some embodiments, the first weight may be determined based on the following:

$$w 1 = ( x >= ( wt / 2 ) ? wt - x : x + 1 ) * ( y >= ( ht / 2 ) ? ht - y : y + 1 ) ,$$

where w1 represents the first weight, x presents a horizontal position of the first sample in the target region, y presents a vertical position of the first sample in the target region, wt represents a width of the target region, and ht represents a height of the target region. The logical operator (a ? b: c) is defined as: if a is TRUE, the output evaluates to the value of b; otherwise, the output evaluates to the value of c.

In some embodiments, the plurality of weights may be determined based on a predetermined probability distribution. By way of example rather than limitation, the predetermined probability distribution may comprise a Gaussian distribution with a predetermined standard deviation. FIG. 7 illustrates weights generated with Gaussian distribution with a standard deviation of 2.5 for a 12×12 region. FIG. 8 illustrates weights generated with Gaussian distribution with a standard deviation of 4 for a 12×12 region. FIG. 9 illustrates weights generated with Gaussian distribution with a standard deviation of 1 for a 5×5 region. FIG. 10 illustrates weights generated with Gaussian distribution with a standard deviation of 2 for a 5×5 region. It should be understood that the above examples are described merely for purpose of description. The scope of the present disclosure is not limited in this respect.

In some embodiments, the plurality of weights may be implemented with shift operations. For example, the plurality of weights may be represented as a left shift matrix or a right shift matrix.

In some embodiments, the plurality of weights may be dependent on a block size, a block shape, a block characteristic, and/or a sequence resolution. In some further embodiments, the plurality of weights may be indicated in a sequence parameter set (SPS), a picture parameter set (PPS), or a slice header (SH).

In some embodiments, whether to apply an BDOF process for MV refinement on the current video block may be dependent on a first condition. Additionally or alternatively, whether to apply a BDOF process for sample adjustment on the current video block may be dependent on a second condition. In one example, the first condition may be the same as the second condition. In another example, the first condition may be different from the second condition. By way of example rather than limitation, the first condition may comprise the current video block is bi-prediction coded with un-equal weights, and the second condition may comprise the current video block is bi-prediction coded with equal weights.

In some embodiments, a subblock size used as a BDOF MV refinement subblock size may be dependent on a condition. For example, the subblock size may be fixed. Alternatively, the subblock size may be dependent on a size of a current prediction unit (PU) may comprise the current video block, a size of a current coding unit (CU) may comprise the current video block, a characteristic of the plurality of reference video blocks, a similarity of a plurality of predictors from the plurality of reference video blocks, a distribution of difference between a plurality of predictors from the plurality of reference video blocks, a temporal gradient of the plurality of reference video blocks, a spatial gradient of the plurality of reference video blocks, a prediction type, an adjustment value determined in a first pass of a multi-pass decoder side motion vector refinement (DMVR), an adjustment value determined in a second pass of the multi-pass DMVR, a sequence resolution, and/or the like.

In some embodiments, the temporal gradient may be determined based on a sum of absolute difference (SAD). In some further embodiments, a height of the subblock size may be dependent on a height or a width of the current video block. Additionally or alternatively, a width of the subblock size may be dependent on a height or a width of the current video block.

In some embodiments, a first cost for evaluating a condition for the BDOF process may be dependent on a second cost between the plurality of reference video blocks. In addition, the second cost may be determined based on different cost functions.

By way of example, the different cost functions may comprise a SAD, a mean-removal SAD (MR-SAD), a sum of absolute transformed difference (SATD), a mean-removal SATD (MR-SATD), a sum of squared differences (SSD), a mean-removal SSD (MR-SSD), a sum of squared errors (SSE), a mean-removal SSE (MR-SSE), a weighted SAD, a weighted MR-SAD, a weighted SATD, a weighted MR-SATD, a weighted SSD, a weighted MR-SSD, a weighted SSE, a weighted MR-SSE, or a gradient information.

In some embodiments, the second cost may be determined based on a SAD between the plurality of reference video blocks, a SATD between the plurality of reference video blocks, a MR-SAD between the plurality of reference video blocks, or a weighted average of at least two of the SAD, the MR-SAD, or the SATD. It should be understood that the above examples are described merely for purpose of description. The scope of the present disclosure is not limited in this respect.

In some embodiments, a filter may be applied on the at least one offset. Compared with the conventional solution where no filtering process is applied, the proposed method can advantageously smooth out the at least one offset, and thus improve the coding quality.

In some embodiments, a filter with a predetermined shape may be applied on a MV determined by the BDOF process for a subblock of the current video block. FIG. 11 illustrates five example filter shapes. In one example, all MVs inside a PU may be used during the application of the filter. In another example, MVs with a same second pass DMVR MVs may be used during the application of the filter.

In some embodiments, the filter has weights. For example, a weight for a center position in the filter may be equal to a third value (such as 1, 4, 8, or the like), and a weight for four sides around the center position may be equal to a fourth value (such as 1, 2, 3, or the like). The third value may be the same as the fourth value. Alternatively, the third value may be different from the fourth value.

In some embodiments, the gradient at a sample may be determined based on a difference between two neighboring samples of the sample. For example, the gradient may comprise a horizontal gradient and/or a vertical gradient. The horizontal gradient and the vertical gradient may be determined based on the following:

$$\frac{\partial {I}^{( k )}}{\partial x} ( i , j ) = ( ( {I}^{( k )} ( i + 1 , j ) ≫ 1 ) - ( {I}^{( k )} ( i - 1 , j ) ≫ 1 ) ) ,$$

$$\frac{\partial {I}^{( k )}}{\partial y} ( i , j ) = ( ( {I}^{( k )} ( i , j + 1 ) ≫ 1 ) - ( {I}^{( k )} ( i , j - 1 ) ≫ 1 ) ) ,$$

where I^{(k)}(i, j) represents a sample value at coordinate (i, j) of a prediction signal of a reference video block of the current video block in a list k, k may be equal to 0 or 1,

$$\frac{\partial {I}^{( k )}}{\partial x} ( i , j )$$

represents a value for the horizontal gradient at coordinate (i, j) of a prediction signal of a reference video block of the current video block in a list k, and

$$\frac{\partial {I}^{( k )}}{\partial y} ( i , j )$$

represents a value for the vertical gradient at coordinate (i, j) of a prediction signal for a reference video block of the current video block in a list k.

In some embodiments, the gradient at a sample may be determined based on a difference between two shifted neighboring samples of the sample. For example, the horizontal gradient and the vertical gradient may be determined based on the following:

$$\frac{\partial {I}^{( k )}}{\partial x} ( i , j ) = ( ( {I}^{( k )} ( i + 1 , j ) ≫ shift 1 ) - ( {I}^{( k )} ( i - 1 , j ) ≫ shift 1 ) ) ,$$

$$\frac{\partial {I}^{( k )}}{\partial y} ( i , j ) = ( ( {I}^{( k )} ( i , j + 1 ) ≫ shift 2 ) - ( {I}^{( k )} ( i , j - 1 ) ≫ shift 2 ) ) ,$$

where I^{(k)}(i, j) represents a sample value at coordinate (i, j) of a prediction signal of a reference video block of the current video block in a list k, k may be equal to 0 or 1,

$$\frac{\partial {I}^{( k )}}{\partial x} ( i , j )$$

represents a value for the horizontal gradient at coordinate (i, j) of a prediction signal of a reference video block of the current video block in a list k,

$$\frac{\partial {I}^{( k )}}{\partial y} ( i , j )$$

represents a value for the vertical gradient at coordinate (i,j) of a prediction signal for a reference video block of the current video block in a list k, and each of shift1 and shift 2 may be an integer, such as 0, 1, 2, 6, or the like.

In some embodiments, the gradient at a sample may be determined based on a first number of samples before the sample and a second number of samples after the sample. In some embodiments, each of the first number and the second number may be an integer. By way of example, the first number and/or the second number may be 0, 3, 10, or the like. For example, the horizontal gradient and the vertical gradient may be determined based on the following:

$$\frac{\partial {I}^{( k )}}{\partial x} ( i , j ) = {\sum }_{p = - Nb}^{Na} whp * {I}^{( k )} ( i + p , j ) ,$$

$$\frac{\partial {I}^{( k )}}{\partial y} ( i , j ) = {\sum }_{p = - Nb}^{Na} wvp * {I}^{( k )} ( i , j + p ) ,$$

where I^{(k)}(i, j) represents a sample value at coordinate (i, j) of a prediction signal of a reference video block of the current video block in a list k, k may be equal to 0 or 1,

$$\frac{\partial {I}^{( k )}}{\partial x} ( i , j )$$

represents a value for the horizontal gradient at coordinate (i, j) of a prediction signal of a reference video block of the current video block in a list k,

$$\frac{\partial {I}^{( k )}}{\partial y} ( i , j )$$

represents a value for the vertical gradient at coordinate (i,j) of a prediction signal for a reference video block of the current video block in a list k, Na represents the second number, Nb represents the first number, and whp represents a weight for a sample at coordinate (i+p, j), and wvp represents a weight for a sample at coordinate (i, j+p).

In some embodiments, weights for determining the horizontal gradient may be the same as weights for determining the vertical gradient. Alternatively, the weights for determining the horizontal gradient may be different from the weights for determining the vertical gradient.

In some embodiments, the weights for determining the horizontal gradient and/or the weights for determining the vertical gradient may be indicated in the bitstream or determined based on coded information.

In some embodiments, the first number and the second number may be different for determining gradients for horizontal and vertical directions. Alternatively, the first number and the second number may be the same for determining gradients for horizontal and vertical directions.

In some embodiments, a division operation may be replaced by a non-division operation, which may employ the same or similar logic to the division-replacement logic in a cross-component linear model (CCLM) or a convolutional cross-component model (CCCM).

In some embodiments, whether to and/or how to apply the method may be dependent on coded information of the current video block. By way of example rather than limitation, the coded information may comprise a block size, a temporal layer a color component, a slice type, and/or a picture type.

In some embodiments, whether to and/or how to apply the method may be indicated in the bitstream. In one example, an indication indicating whether to enable the method or a method to be applied may be indicated at a sequence level, a group of pictures level, a picture level, a slice level, a tile group level, or the like.

In some embodiments, an indication indicating whether to enable the method or a method to be applied may be indicated in a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

In some embodiments, an indication indicating whether to enable the method or a method to be applied may be indicated at a region may comprise more one sample or pixel. By way of example, the region may comprise a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, or a sub-picture.

It should be understood that the above illustrations and/or examples are described merely for purpose of description. The scope of the present disclosure is not limited in this respect. Moreover, the specific values recited herein are intended to be exemplary rather than limiting the scope of the present

According to further embodiments of the present disclosure, a non-transitory computer-readable recording medium is provided. The non-transitory computer-readable recording medium stores a bitstream of a video which is generated by a method performed by an apparatus for video processing. In the method, a plurality of weights are obtained. The plurality of weights are used to weight a plurality of values for a metric at respective samples in a target region for a bi-directional optical flow (BDOF) process applied on a current video block of the video. The metric comprises at least one of a gradient or a difference of sample value. The plurality of values for the metric are determined based on a plurality of reference video blocks of the current video block. Moreover, the bitstream is generated based on the plurality of weights.

According to still further embodiments of the present disclosure, a method for storing bitstream of a video is provided. In the method, a plurality of weights are obtained. The plurality of weights are used to weight a plurality of values for a metric at respective samples in a target region for a bi-directional optical flow (BDOF) process applied on a current video block of the video. The metric comprises at least one of a gradient or a difference of sample value. The plurality of values for the metric are determined based on a plurality of reference video blocks of the current video block. Moreover, the bitstream is generated based on the plurality of weights, and stored in a non-transitory computer-readable recording medium.

Implementations of the present disclosure can be described in view of the following clauses, the features of which can be combined in any reasonable manner.

Clause 1. A method for video processing, comprising: obtaining, for a conversion between a current video block of a video and a bitstream of the video, a plurality of weights, wherein the plurality of weights are used to weight a plurality of values for a metric at respective samples in a target region for a bi-directional optical flow (BDOF) process applied on the current video block, the metric comprises at least one of a gradient or a difference of sample values, and the plurality of values for the metric are determined based on a plurality of reference video blocks of the current video block; and performing the conversion based on the plurality of weights.

Clause 2. The method of clause 1, wherein performing the conversion comprises: determining a set of parameters for the BDOF process based on the plurality of weights; determining, based on the set of parameters, at least one offset for refining a motion vector (MV) of the current video block or adjusting a current sample in the current video block; and performing the conversion based on the at least one offset.

Clause 3. The method of clause 2, wherein the at least one offset is used for refining the motion vector of the current video block, a size of the current video block is M×N, the target region comprises a region around the current video block of a size (M+K1)×(N+K2), and each of M, N, K1 and K2 is an integer, or wherein the at least one offset is used for adjusting the current sample, the target region comprises a region around the current sample with a size of K3×K4, and each of K3 and K4 is an integer.

Clause 4. The method of any of clauses 2-3, wherein the set of parameters for the BDOF process is determined based on the plurality of weights and a complete linear equation formula.

Clause 5. The method of any of clauses 2-4, wherein the set of parameters comprises a first parameter, a second parameter, a third parameter, a fourth parameter, and a fifth parameter that are determined in a predetermined manner.

Clause 6. The method of clause 5, wherein the gradient comprises at least one of a horizontal gradient or a vertical gradient, and the set of parameters is determined based on the following:

$$s 1 = \sum ( Gx \cdot Gx ) ,$$

$$s 2 = \sum ( Gx \cdot Gy ) ,$$

$$s 3 = \sum ( dI \cdot Gx ) ,$$

$$s 5 = \sum ( Gy \cdot Gx ) ,$$

$$s 6 = \sum ( dI \cdot Gy ) ,$$

wherein s1 represents the first parameter, s2 represents the second parameter, s3 represents the third parameter, s5 represents the fourth parameter, s6 represents the fifth parameter, Gx represents a summation of values for the horizontal gradient determined for each of the plurality of reference video blocks, Gy represents a summation of values for the vertical gradient determined for each of the plurality of reference video blocks, dI represents the difference of sample values between the plurality of reference video blocks, and Σ() represents a weighted sum inside the target region based on the plurality of weights.

Clause 7. The method of clause 5, wherein the gradient comprises at least one of a horizontal gradient or a vertical gradient, and the set of parameters is determined based on the following:

$$s 1 = {\sum }_{( i , j ) ∈ Ω} Abs ( {ψ}_{x} ( i , j ) ) ,$$

$$s 2 = {\sum }_{( i , j ) ∈ Ω} {ψ}_{x} ( i , j ) \cdot Sign ( {ψ}_{y} ( i , j ) ) ,$$

$$s 3 = {\sum }_{( i , j ) ∈ Ω} θ ( i , j ) \cdot Sign ( {ψ}_{x} ( i , j ) ) ,$$

$$s 4 = {\sum }_{( i , j ) ∈ Ω} Abs ( {ψ}_{y} ( i , j ) ) ,$$

$$s5 = {\sum }_{( i , j ) ∈ Ω} θ ( i , j ) \cdot Sign ( {ψ}_{y} ( i , j ) ) ,$$

$${ψ}_{x} ( i , j ) = ( \frac{\partial {I}^{( 1 )}}{\partial x} ( i , j ) + \frac{\partial {I}^{( 0 )}}{\partial x} ( i , j ) ) ≫ na ,$$

$${ψ}_{y} ( i , j ) = ( \frac{\partial {I}^{( 1 )}}{\partial y} ( i , j ) + \frac{\partial {I}^{( 0 )}}{\partial y} ( i , j ) ) ≫ na ,$$

$$θ ( i , j ) = ( {I}^{( 1 )} ( i , j ) ≫ nb ) - ( {I}^{( 0 )} ( i , j ) ≫ nb ) ,$$

wherein s1 represents the first parameter, s2 represents the second parameter, s3 represents the third parameter, s5 represents the fourth parameter, s6 represents the fifth parameter, I^{(k)}(i, j) represents a sample value at coordinate (i, j) of a prediction signal of a reference video block of the current video block in a list k, k is equal to 0 or 1,

$$\frac{\partial {I}^{( k )}}{\partial x} ( i , j )$$

represents a value for the horizontal gradient at coordinate (i, j) of a prediction signal of a reference video block of the current video block in a list k,

$$\frac{\partial {I}^{( k )}}{\partial y} ( i , j )$$

represents a value for the vertical gradient at coordinate (i, j) of a prediction signal for a reference video block of the current video block in a list k, Σ_{(i,j)∈Ω}() represents a weighted sum inside the target region Ω based on the plurality of weights, abs(z) represents an absolute value of a number z, sign(z) represent a sign of a number z, and each of na and nb is an integer.

Clause 8. The method of any of clauses 5-7, wherein determining the at least one offset comprises: determining a set of determinant values based on the set of parameters; and determining the at least one offset based on the set of determinant values.

Clause 9. The method of clause 8, wherein the set of determinant values are determined based on the following:

$$D = ( s 1 >> shTem ) * ( s 5 >> shTem ) - ( s 2 >> shTem ) * ( s 2 >> shTem ) , \\ Dx = ( s 3 >> shTem ) * ( s 5 >> shTem ) - ( s 6 >> shTem ) * ( s 2 >> shTem ) , \\ Dy = ( s 1 >> shTem ) * ( s 6 >> shTem ) - ( s 3 >> shTem ) * ( s 2 >> shTem ) ,$$

wherein D represents a first determinant value in the set of determinant values, Dx represents a second determinant value in the set of determinant values, Dy represents a third determinant value in the set of determinant values, s1 represents the first parameter, s2 represents the second parameter, s3 represents the third parameter, s5 represents the fourth parameter, s6 represents the fifth parameter, and shTem is an integer.

Clause 10. The method of clause 9, wherein the at least one offset is determined based on the following: vx=Dx/D, vy=Dy/D, where vx represents a first offset in the at least one offset, and vy represents a second offset in the at least one offset.

Clause 11. The method of any of clauses 9-10, wherein if the absolute value of the first determinant value is smaller than a predetermined threshold, each of the at least one offset is equal to a predetermined value.

Clause 12. The method of clause 11, wherein the predetermined threshold is a non-negative number.

Clause 13. The method of any of clauses 5-7, wherein a first offset in the at least one offset is determined based on the set of parameters, and a second offset in the at least one offset is determined based on the first offset and the set of parameters.

Clause 14. The method of clause 13, wherein the at least one offset is determined based on the following: vx=s3/s1, vy=(s6−s2*vx)/s5, wherein vx represents the first offset, vy represents the second offset, s1 represents the first parameter, s2 represents the second parameter, s3 represents the third parameter, s5 represents the fourth parameter, and s6 represents the fifth parameter.

Clause 15. The method of clause 13, wherein the first offset and the second offset are determined based on the following: vx=s3/s1, vy=(s6−s2*vx/T1)/s5, wherein vx represents the first offset, vy represents the second offset, s1 represents the first parameter, s2 represents the second parameter, s3 represents the third parameter, s5 represents the fourth parameter, s6 represents the fifth parameter, and T1 presents a real number.

Clause 16. The method of any of clauses 5-7, wherein a second offset in the at least one offset is determined based on the set of parameters, and a first offset in the at least one offset is determined based on the second offset and the set of parameters.

Clause 17. The method of clause 16, wherein the first offset and the second offset are determined based on the following: vy=s6/s5, vx=(s3−s2*vy)/s1, wherein vx represents the first offset, vy represents the second offset, s1 represents the first parameter, s2 represents the second parameter, s3 represents the third parameter, s5 represents the fourth parameter, and s6 represents the fifth parameter.

Clause 18. The method of clause 16, wherein the first offset and the second offset are determined based on the following: vy=s6/s5, vx=(s3−s2*vy/T2)/s1, wherein vx represents the first offset, vy represents the second offset, s1 represents the first parameter, s2 represents the second parameter, s3 represents the third parameter, s5 represents the fourth parameter, s6 represents the fifth parameter, and T2 presents a real number.

Clause 19. The method of any of clauses 5-7, wherein the at least one offset is determined based on the following: vx=s3/s1, vy=s6/s5, wherein vx represents a first offset in the at least one offset, vy represents a second offset in the at least one offset, s1 represents the first parameter, s3 represents the third parameter, s5 represents the fourth parameter, and s6 represents the fifth parameter.

Clause 20. The method of any of clauses 2-19, wherein a shift operation or a clip operation is used for determining the at least one offset.

Clause 21. The method of clause 20, wherein the shift operation is applied on at least one of a numerator or a denominator of a term in an equation for determining the at least one offset.

Clause 22. The method of any of clauses 20-21, wherein the shift operation comprises left shifting by a predetermined number of bits.

Clause 23. The method of any of clauses 20-22, wherein the shift operation is applied in a predetermined order.

Clause 24. The method of any of clauses 20-23, wherein the clip operation is applied on the at least one offset to update the at least one offset.

Clause 25. The method of clause 24, wherein a value of the at least one updated offset is between a first value and a second value.

Clause 26. The method of any of clauses 2-25, wherein performing the conversion based on the at least one offset comprises: adjusting the at least one offset with at least one scaling factor; and performing the conversion based on the at least one adjusted offset.

Clause 27. The method of clause 26, wherein a first offset in the at least one offset is adjusted by multiplying the first offset by a first scaling factor in the at least one scaling factor, and the first scaling factor is a real number.

Clause 28. The method of clause 26, wherein a second offset in the at least one offset is adjusted by dividing the second offset by a second scaling factor in the at least one scaling factor, and the second scaling factor is a real number.

Clause 29. The method of any of clauses 26-28, wherein different offsets in the at least one offset are adjusted with different scaling factors in the at least one scaling factor.

Clause 30. The method of any of clauses 26-29, wherein the at least one scaling factor is dependent on at least one of the following: a block size, a sequence resolution, or a block characteristic.

Clause 31. The method of any of clauses 1-30, wherein each of the plurality of weights is equal to a same predetermined value.

Clause 32. The method of any of clauses 1-30, wherein a first weight of the plurality of weights that corresponds to a first sample in the target region is dependent on a position of the first sample in the target region.

Clause 33. The method of clause 32, wherein the first weight is determined based on the following: w1=(x>=(wt/2)? wt−x:x+1)*(y>=(ht/2)? ht−y:y+1), wherein w1 represents the first weight, x presents a horizontal position of the first sample in the target region, y presents a vertical position of the first sample in the target region, wt represents a width of the target region, and ht represents a height of the target region.

Clause 34. The method of any of clauses 1-30, wherein the plurality of weights are determined based on a predetermined probability distribution.

Clause 35. The method of clause 34, wherein the predetermined probability distribution comprises a Gaussian distribution with a predetermined standard deviation.

Clause 36. The method of any of clauses 1-30, wherein the plurality of weights are implemented with shift operations.

Clause 37. The method of clause 36, wherein the plurality of weights are represented as a left shift matrix or a right shift matrix.

Clause 38. The method of any of clauses 1-37, wherein the plurality of weights are dependent on at least one of the following: a block size, a block shape, a block characteristic, or a sequence resolution.

Clause 39. The method of any of clauses 1-38, wherein the plurality of weights are indicated in one of the following: a sequence parameter set (SPS), a picture parameter set (PPS), or a slice header (SH).

Clause 40. The method of any of clauses 1-39, wherein whether to apply an BDOF process for MV refinement on the current video block is dependent on a first condition, or whether to apply a BDOF process for sample adjustment on the current video block is dependent on a second condition.

Clause 41. The method of clause 40, wherein the first condition is the same as the second condition.

Clause 42. The method of clause 40, wherein the first condition is different from the second condition.

Clause 43. The method of clause 42, wherein the first condition comprises the current video block is bi-prediction coded with un-equal weights, and the second condition comprises the current video block is bi-prediction coded with equal weights.

Clause 44. The method of any of clauses 1-43, wherein a subblock size used as a BDOF MV refinement subblock size is dependent on a condition.

Clause 45. The method of clause 44, wherein the subblock size is fixed.

Clause 46. The method of clause 44, wherein the subblock size is dependent on at least one of the following: a size of a current prediction unit (PU) comprising the current video block, a size of a current coding unit (CU) comprising the current video block, a characteristic of the plurality of reference video blocks, a similarity of a plurality of predictors from the plurality of reference video blocks, a distribution of difference between a plurality of predictors from the plurality of reference video blocks, a temporal gradient of the plurality of reference video blocks, a spatial gradient of the plurality of reference video blocks, a prediction type, an adjustment value determined in a first pass of a multi-pass decoder side motion vector refinement (DMVR), an adjustment value determined in a second pass of the multi-pass DMVR, or a sequence resolution.

Clause 47. The method of clause 46, wherein the temporal gradient is determined based on a sum of absolute difference (SAD).

Clause 48. The method of clause 44, wherein a height of the subblock size is dependent on a height or a width of the current video block, or a width of the subblock size is dependent on a height or a width of the current video block.

Clause 49. The method of any of clauses 1-48, wherein a first cost for evaluating a condition for the BDOF process is dependent on a second cost between the plurality of reference video blocks.

Clause 50. The method of clause 49, wherein the second cost is determined based on different cost functions.

Clause 51. The method of clause 50, wherein the different cost functions comprise at least one of the following: a SAD, a mean-removal SAD (MR-SAD), a sum of absolute transformed difference (SATD), a mean-removal SATD (MR-SATD), a sum of squared differences (SSD), a mean-removal SSD (MR-SSD), a sum of squared errors (SSE), a mean-removal SSE (MR-SSE), a weighted SAD, a weighted MR-SAD, a weighted SATD, a weighted MR-SATD, a weighted SSD, a weighted MR-SSD, a weighted SSE, a weighted MR-SSE, or a gradient information.

Clause 52. The method of clause 49, wherein the second cost is determined based on at least one of the following: a SAD between the plurality of reference video blocks, a SATD between the plurality of reference video blocks, a MR-SAD between the plurality of reference video blocks, or a weighted average of at least two of the SAD, the MR-SAD, or the SATD.

Clause 53. The method of any of clauses 2-52, wherein a filter is applied on the at least one offset.

Clause 54. The method of any of clauses 2-52, wherein a filter with a predetermined shape is applied on a MV determined by the BDOF process for a subblock of the current video block.

Clause 55. The method of any of clauses 53-54, wherein all MVs inside a PU are used during the application of the filter.

Clause 56. The method of any of clauses 53-54, wherein MVs with a same second pass DMVR MVs are used during the application of the filter.

Clause 57. The method of any of clauses 53-56, wherein the filter has weights.

Clause 58. The method of clause 57, wherein a weight for a center position in the filter is equal to a third value, and a weight for four sides around the center position is equal to a fourth value.

Clause 59. The method of clause 58, wherein the third value is the same as the fourth value, or the third value is different from the fourth value.

Clause 60. The method of any of clauses 1-59, wherein the gradient at a sample is determined based on a difference between two neighboring samples of the sample.

Clause 61. The method of clause 60, wherein the gradient comprises at least one of a horizontal gradient or a vertical gradient that are determined based on the following:

$$\frac{\partial {I}^{( k )}}{\partial x} ( i , j ) = ( ( {I}^{( k )} ( i + 1 , j ) ≫ 1 ) - ( {I}^{( k )} ( i - 1 , j ) ≫ 1 ) ) , \\ \frac{\partial {I}^{( k )}}{\partial y} ( i , j ) = ( ( {I}^{( k )} ( i , j + 1 ) ≫ 1 ) - ( {I}^{( k )} ( i , j - 1 ) ≫ 1 ) ) ,$$

wherein I^{(k)}(i, j) represents a sample value at coordinate (i, j) of a prediction signal of a reference video block of the current video block in a list k, k is equal to 0 or 1,

$$\frac{\partial {I}^{( k )}}{\partial x} ( i , j )$$

represents a value for the horizontal gradient at coordinate (i, j) of a prediction signal of a reference video block of the current video block in a list k, and

$$\frac{\partial {I}^{( k )}}{\partial y} ( i , j )$$

represents a value for the vertical gradient at coordinate (i,j) of a prediction signal for a reference video block of the current video block in a list k.

Clause 62. The method of any of clauses 1-59, wherein the gradient at a sample is determined based on a difference between two shifted neighboring samples of the sample.

Clause 63. The method of clause 62, wherein the gradient comprises at least one of a horizontal gradient or a vertical gradient that are determined based on the following:

$$\frac{\partial {I}^{( k )}}{\partial x} ( i , j ) = ( ( {I}^{( k )} ( i + 1 , j ) ≫ shift1 ) - ( {I}^{( k )} ( i - 1 , j ) ≫ shift1 ) ) , \\ \frac{\partial {I}^{( k )}}{\partial y} ( i , j ) = ( ( {I}^{( k )} ( i , j + 1 ) ≫ shift2 ) - ( {I}^{( k )} ( i , j - 1 ) ≫ shift2 ) ) ,$$

wherein I^{(k)}(i, j) represents a sample value at coordinate (i, j) of a prediction signal of a reference video block of the current video block in a list k, k is equal to 0 or 1,

$$\frac{\partial {I}^{( k )}}{\partial x} ( i , j )$$

represents a value for the horizontal gradient at coordinate (i, j) of a prediction signal of a reference video block of the current video block in a lit k,

$$\frac{\partial {I}^{( k )}}{\partial y} ( i , j )$$

represents a value for the vertical gradient at coordinate (i,j) of a prediction signal for a reference video block of the current video block in a list k, and each of shift1 and shift 2 is an integer.

Clause 64. The method of any of clauses 1-59, wherein the gradient at a sample is determined based on a first number of samples before the sample and a second number of samples after the sample.

Clause 65. The method of clause 64, wherein the gradient comprises at least one of a horizontal gradient or a vertical gradient that are determined based on the following:

$$\frac{\partial {I}^{( k )}}{\partial x} ( i , j ) = {\sum }_{p = - Nb}^{Na} whp * {I}^{( k )} ( i + p , j ) , \\ \frac{\partial {I}^{( k )}}{\partial y} ( i , j ) = {\sum }_{p = - Nb}^{Na} wvp * {I}^{( k )} ( i , j + p ) ,$$

wherein I^{(k)}(i, j) represents a sample value at coordinate (i, j) of a prediction signal of a reference video block of the current video block in a list k, k is equal to 0 or 1,

$$\frac{\partial {I}^{( k )}}{\partial x} ( i , j )$$

represents a value for the horizontal gradient at coordinate (i, j) of a prediction signal of a reference video block of the current video block in a list k,

$$\frac{\partial {I}^{( k )}}{\partial y} ( i , j )$$

represents a value for the vertical gradient at coordinate (i, j) of a prediction signal for a reference video block of the current video block in a list k, Na represents the second number, Nb represents the first number, and whp represents a weight for a sample at coordinate (i+p,j), and wvp represents a weight for a sample at coordinate (i, j+p).

Clause 66. The method of clause 65, wherein weights for determining the horizontal gradient are the same as weights for determining the vertical gradient, or the weights for determining the horizontal gradient are different from the weights for determining the vertical gradient.

Clause 67. The method of clause 66, wherein the weights for determining the horizontal gradient and/or the weights for determining the vertical gradient are indicated in the bitstream or determined based on coded information.

Clause 68. The method of any of clauses 64-67, wherein each of the first number and the second number is an integer.

Clause 69. The method of any of clauses 64-68, wherein the first number and the second number are different for determining gradients for horizontal and vertical directions, or the first number and the second number are the same for determining gradients for horizontal and vertical directions.

Clause 70. The method of any of clauses 1-69, wherein a division operation is replaced by a non-division operation.

Clause 71. The method of any of clauses 1-70, wherein whether to and/or how to apply the method is dependent on coded information of the current video block.

Clause 72. The method of clause 71, wherein the coded information comprises at least one of the following: a block size, a temporal layer a color component, a slice type, or a picture type.

Clause 73. The method of any of clauses 1-72, wherein whether to and/or how to apply the method is indicated in the bitstream.

Clause 74. The method of any of clauses 1-72, wherein an indication indicating whether to enable the method or a method to be applied is indicated at one of the following: a sequence level, a group of pictures level, a picture level, a slice level, or a tile group level.

Clause 75. The method of any of clauses 1-72, wherein an indication indicating whether to enable the method or a method to be applied is indicated in one of the following: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

Clause 76. The method of any of clauses 1-72, wherein an indication indicating whether to enable the method or a method to be applied is indicated at a region comprising more one sample or pixel.

Clause 77. The method of clause 76, wherein the region comprises one of the following: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, or a sub-picture.

Clause 78. The method of any of clauses 1-77, wherein the conversion includes encoding the current video block into the bitstream.

Clause 79. The method of any of clauses 1-77, wherein the conversion includes decoding the current video block from the bitstream.

Clause 80. An apparatus for video processing comprising a processor and a non-transitory memory with instructions thereon, wherein the instructions upon execution by the processor, cause the processor to perform a method in accordance with any of clauses 1-79.

Clause 81. A non-transitory computer-readable storage medium storing instructions that cause a processor to perform a method in accordance with any of clauses 1-79.

Clause 82. A non-transitory computer-readable recording medium storing a bitstream of a video which is generated by a method performed by an apparatus for video processing, wherein the method comprises: obtaining a plurality of weights, wherein the plurality of weights are used to weight a plurality of values for a metric at respective samples in a target region for a bi-directional optical flow (BDOF) process applied on a current video block of the video, the metric comprises at least one of a gradient or a difference of sample values, and the plurality of values for the metric are determined based on a plurality of reference video blocks of the current video block; and generating the bitstream based on the plurality of weights.

Clause 83. A method for storing a bitstream of a video, comprising: obtaining a plurality of weights, wherein the plurality of weights are used to weight a plurality of values for a metric at respective samples in a target region for a bi-directional optical flow (BDOF) process applied on a current video block of the video, the metric comprises at least one of a gradient or a difference of sample values, and the plurality of values for the metric are determined based on a plurality of reference video blocks of the current video block; generating the bitstream based on the plurality of weights; and storing the bitstream in a non-transitory computer-readable recording medium.

### Example Device

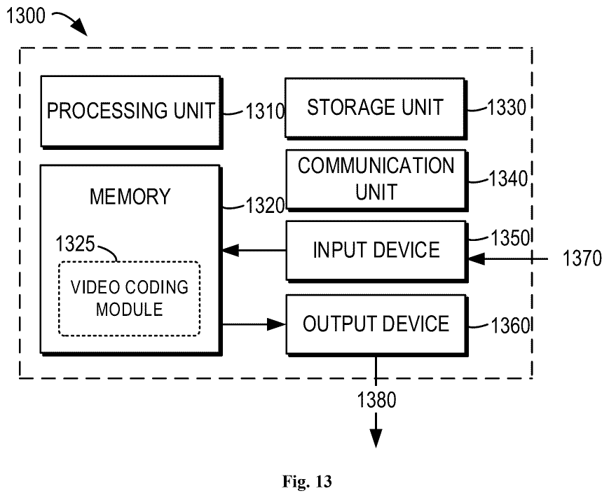

FIG. 13 illustrates a block diagram of a computing device 1300 in which various embodiments of the present disclosure can be implemented. The computing device 1300 may be implemented as or included in the source device 110 (or the video encoder 114 or 200) or the destination device 120 (or the video decoder 124 or 300).

It would be appreciated that the computing device 1300 shown in FIG. 13 is merely for purpose of illustration, without suggesting any limitation to the functions and scopes of the embodiments of the present disclosure in any manner.

As shown in FIG. 13, the computing device 1300 includes a general-purpose computing device 1300. The computing device 1300 may at least comprise one or more processors or processing units 1310, a memory 1320, a storage unit 1330, one or more communication units 1340, one or more input devices 1350, and one or more output devices 1360.

In some embodiments, the computing device 1300 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 1300 can support any type of interface to a user (such as “wearable” circuitry and the like).

The processing unit 1310 may be a physical or virtual processor and can implement various processes based on programs stored in the memory 1320. In a multi-processor system, multiple processing units execute computer executable instructions in parallel so as to improve the parallel processing capability of the computing device 1300. The processing unit 1310 may also be referred to as a central processing unit (CPU), a microprocessor, a controller or a microcontroller.

The computing device 1300 typically includes various computer storage medium. Such medium can be any medium accessible by the computing device 1300, including, but not limited to, volatile and non-volatile medium, or detachable and non-detachable medium. The memory 1320 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 1330 may be any detachable or non-detachable medium and may include a machine-readable medium such as a memory, flash memory drive, magnetic disk or another other media, which can be used for storing information and/or data and can be accessed in the computing device 1300.

The computing device 1300 may further include additional detachable/non-detachable, volatile/non-volatile memory medium. Although not shown in FIG. 13, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 1340 communicates with a further computing device via the communication medium. In addition, the functions of the components in the computing device 1300 can be implemented by a single computing cluster or multiple computing machines that can communicate via communication connections. Therefore, the computing device 1300 can operate in a networked environment using a logical connection with one or more other servers, networked personal computers (PCs) or further general network nodes.

The input device 1350 may be one or more of a variety of input devices, such as a mouse, keyboard, tracking ball, voice-input device, and the like. The output device 1360 may be one or more of a variety of output devices, such as a display, loudspeaker, printer, and the like. By means of the communication unit 1340, the computing device 1300 can further communicate with one or more external devices (not shown) such as the storage devices and display device, with one or more devices enabling the user to interact with the computing device 1300, or any devices (such as a network card, a modem and the like) enabling the computing device 1300 to communicate with one or more other computing devices, if required. Such communication can be performed via input/output (I/O) interfaces (not shown).

In some embodiments, instead of being integrated in a single device, some or all components of the computing device 1300 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 1300 may be used to implement video encoding/decoding in embodiments of the present disclosure. The memory 1320 may include one or more video coding modules 1325 having one or more program instructions. These modules are accessible and executable by the processing unit 1310 to perform the functionalities of the various embodiments described herein.

In the example embodiments of performing video encoding, the input device 1350 may receive video data as an input 1370 to be encoded. The video data may be processed, for example, by the video coding module 1325, to generate an encoded bitstream. The encoded bitstream may be provided via the output device 1360 as an output 1380.

In the example embodiments of performing video decoding, the input device 1350 may receive an encoded bitstream as the input 1370. The encoded bitstream may be processed, for example, by the video coding module 1325, to generate decoded video data. The decoded video data may be provided via the output device 1360 as the output 1380.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/we claim:

1. A method for video processing, comprising:
obtaining, for a conversion between a current video block of a video and a bitstream of the video, a plurality of weights, wherein the plurality of weights are used to weight a plurality of values for a metric at respective samples in a target region for a bi-directional optical flow (BDOF) process applied on the current video block, the metric comprises at least one of a gradient or a difference of sample values, and the plurality of values for the metric are determined based on a plurality of reference video blocks of the current video block; and
performing the conversion based on the plurality of weights.

2. The method of claim 1, wherein performing the conversion comprises:
determining a set of parameters for the BDOF process based on the plurality of weights;
determining, based on the set of parameters, at least one offset for refining a motion vector (MV) of the current video block or adjusting a current sample in the current video block; and
performing the conversion based on the at least one offset.

3. The method of claim 2, wherein the at least one offset is used for refining the motion vector of the current video block, a size of the current video block is M×N, the target region comprises a region around the current video block of a size (M+K1)×(N+K2), and each of M, N, K1 and K2 is an integer, or
wherein the at least one offset is used for adjusting the current sample, the target region comprises a region around the current sample with a size of K3×K4, and each of K3 and K4 is an integer, or
wherein the set of parameters for the BDOF process is determined based on the plurality of weights and a complete linear equation formula, or
wherein the set of parameters comprises a first parameter, a second parameter, a third parameter, a fourth parameter, and a fifth parameter that are determined in a predetermined manner.

4. The method of claim 3, wherein the gradient comprises at least one of a horizontal gradient or a vertical gradient, and the set of parameters is determined based on the following:
$$s 1 = \sum ( Gx \cdot Gx ) , \\ s 2 = \sum ( Gx \cdot Gy ) , \\ s 3 = \sum ( dI \cdot Gx ) , \\ s 5 = \sum ( Gy \cdot Gx ) , \\ s 6 = \sum ( dI \cdot Gy ) ,$$
wherein s1 represents the first parameter, s2 represents the second parameter, s3 represents the third parameter, s5 represents the fourth parameter, s6 represents the fifth parameter, Gx represents a summation of values for the horizontal gradient determined for each of the plurality of reference video blocks, Gy represents a summation of values for the vertical gradient determined for each of the plurality of reference video blocks, dI represents the difference of sample values between the plurality of reference video blocks, and Σ() represents a weighted sum inside the target region based on the plurality of weights, or
wherein the gradient comprises at least one of a horizontal gradient or a vertical gradient, and the set of parameters is determined based on the following:
$$s 1 = {\sum }_{( i , j ) ∈ Ω} Abs ( {ψ}_{x} ( i , j ) ) , \\ s 2 = {\sum }_{( i , j ) ∈ Ω} {ψ}_{x} ( i , j ) \cdot Sign ( {ψ}_{y} ( i , j ) ) , \\ s 3 = {\sum }_{( i , j ) ∈ Ω} θ ( i , j ) \cdot Sign ( {ψ}_{x} ( i , j ) ) , \\ s 4 = {\sum }_{( i , j ) ∈ Ω} Abs ( {ψ}_{y} ( i , j ) ) , \\ s 5 = {\sum }_{( i , j ) ∈ Ω} θ ( i , j ) \cdot Sign ( {ψ}_{y} ( i , j ) ) , \\ {ψ}_{x} ( i , j ) = ( \frac{\partial {I}^{( 1 )}}{\partial x} ( i , j ) + \frac{\partial {I}^{( 0 )}}{\partial x} ( i , j ) ) ≫ na , \\ {ψ}_{y} ( i , j ) = ( \frac{\partial {I}^{( 1 )}}{\partial y} ( i , j ) + \frac{\partial {I}^{( 0 )}}{\partial y} ( i , j ) ) ≫ na , \\ θ ( i , j ) = ( {I}^{( 1 )} ( i , j ) ≫ nb ) - ( {I}^{( 0 )} ( i , j ) ≫ nb ) ,$$
wherein s1 represents the first parameter, s2 represents the second parameter, s3 represents the third parameter, s5 represents the fourth parameter, s6 represents the fifth parameter, I^{(k)}(i, j) represents a sample value at coordinate (i, j) of a prediction signal of a reference video block of the current video block in a list k, k is equal to 0 or 1,
$$\frac{\partial {I}^{( k )}}{\partial x} ( i , j )$$
represents a value for the horizontal gradient at coordinate (i, j) of a prediction signal of a reference video block of the current video block in a list k,
$$\frac{\partial {I}^{( k )}}{\partial y} ( i , j )$$
represents a value for the vertical gradient at coordinate (i, j) of a prediction signal for a reference video block of the current video block in a list k, Σ_{(i,j)∈Ω}() represents a weighted sum inside the target region Ω based on the plurality of weights, abs(z) represents an absolute value of a number z, sign(z) represent a sign of a number z, and each of na and nb is an integer, or
wherein determining the at least one offset comprises: determining a set of determinant values based on the set of parameters; and determining the at least one offset based on the set of determinant values, or
wherein a first offset in the at least one offset is determined based on the set of parameters, and a second offset in the at least one offset is determined based on the first offset and the set of parameters, or
wherein a second offset in the at least one offset is determined based on the set of parameters, and a first offset in the at least one offset is determined based on the second offset and the set of parameters, or
wherein the at least one offset is determined based on the following:
$$vx = s 3 / s 1 , \\ vy = s 6 / s 5 ,$$
wherein vx represents a first offset in the at least one offset, vy represents a second offset in the at least one offset, s1 represents the first parameter, s3 represents the third parameter, s5 represents the fourth parameter, and s6 represents the fifth parameter.

5. The method of claim 2, wherein a shift operation or a clip operation is used for determining the at least one offset.

6. The method of claim 5, wherein the shift operation is applied on at least one of a numerator or a denominator of a term in an equation for determining the at least one offset, or
wherein the shift operation comprises left shifting by a predetermined number of bits, or
wherein the shift operation is applied in a predetermined order, or
wherein the clip operation is applied on the at least one offset to update the at least one offset.

7. The method of claim 2, wherein performing the conversion based on the at least one offset comprises:
adjusting the at least one offset with at least one scaling factor; and
performing the conversion based on the at least one adjusted offset.

8. The method of claim 7, wherein a first offset in the at least one offset is adjusted by multiplying the first offset by a first scaling factor in the at least one scaling factor, and the first scaling factor is a real number, or
wherein a second offset in the at least one offset is adjusted by dividing the second offset by a second scaling factor in the at least one scaling factor, and the second scaling factor is a real number, or
wherein different offsets in the at least one offset are adjusted with different scaling factors in the at least one scaling factor, or
wherein the at least one scaling factor is dependent on at least one of the following: a block size, a sequence resolution, or a block characteristic.

9. The method of claim 1, wherein each of the plurality of weights is equal to a same predetermined value, or
wherein a first weight of the plurality of weights that corresponds to a first sample in the target region is dependent on a position of the first sample in the target region, or
wherein the plurality of weights are determined based on a predetermined probability distribution, or
wherein the plurality of weights are implemented with shift operations, or
wherein the plurality of weights are dependent on at least one of the following: a block size, a block shape, a block characteristic, or a sequence resolution, or
wherein the plurality of weights are indicated in one of the following: a sequence parameter set (SPS), a picture parameter set (PPS), or a slice header (SH), or
wherein whether to apply an BDOF process for MV refinement on the current video block is dependent on a first condition, or
whether to apply a BDOF process for sample adjustment on the current video block is dependent on a second condition.

10. The method of claim 1, wherein a subblock size used as a BDOF MV refinement subblock size is dependent on a condition.

11. The method of claim 10, wherein the subblock size is fixed, or
wherein the subblock size is dependent on at least one of the following:
a size of a current prediction unit (PU) comprising the current video block,
a size of a current coding unit (CU) comprising the current video block,
a characteristic of the plurality of reference video blocks,
a similarity of a plurality of predictors from the plurality of reference video blocks,
a distribution of difference between a plurality of predictors from the plurality of reference video blocks,
a temporal gradient of the plurality of reference video blocks,
a spatial gradient of the plurality of reference video blocks,
a prediction type,
an adjustment value determined in a first pass of a multi-pass decoder side motion vector refinement (DMVR),
an adjustment value determined in a second pass of the multi-pass DMVR, or
a sequence resolution, or
wherein a height of the subblock size is dependent on a height or a width of the current video block, or a width of the subblock size is dependent on a height or a width of the current video block.

12. The method of claim 1, wherein a first cost for evaluating a condition for the BDOF process is dependent on a second cost between the plurality of reference video blocks.

13. The method of claim 2, wherein a filter is applied on the at least one offset, or
wherein a filter with a predetermined shape is applied on a MV determined by the BDOF process for a subblock of the current video block.

14. The method of claim 1, wherein the gradient at a sample is determined based on a difference between two neighboring samples of the sample, or
wherein the gradient at a sample is determined based on a difference between two shifted neighboring samples of the sample, or
wherein the gradient at a sample is determined based on a first number of samples before the sample and a second number of samples after the sample.

15. The method of claim 1, wherein a division operation is implemented with at least one non-division operation.

16. The method of claim 1, wherein the conversion includes encoding the current video block into the bitstream.

17. The method of claim 1, wherein the conversion includes decoding the current video block from the bitstream.

18. An apparatus for video processing comprising a processor and a non-transitory memory with instructions thereon, wherein the instructions upon execution by the processor, cause the processor to perform acts comprising:
obtaining, for a conversion between a current video block of a video and a bitstream of the video, a plurality of weights, wherein the plurality of weights are used to weight a plurality of values for a metric at respective samples in a target region for a bi-directional optical flow (BDOF) process applied on the current video block, the metric comprises at least one of a gradient or a difference of sample values, and the plurality of values for the metric are determined based on a plurality of reference video blocks of the current video block; and
performing the conversion based on the plurality of weights.

19. A non-transitory computer-readable storage medium storing instructions that cause a processor to perform acts comprising:
obtaining, for a conversion between a current video block of a video and a bitstream of the video, a plurality of weights, wherein the plurality of weights are used to weight a plurality of values for a metric at respective samples in a target region for a bi-directional optical flow (BDOF) process applied on the current video block, the metric comprises at least one of a gradient or a difference of sample values, and the plurality of values for the metric are determined based on a plurality of reference video blocks of the current video block; and
performing the conversion based on the plurality of weights.

20. A non-transitory computer-readable recording medium storing a bitstream of a video which is generated by a method performed by an apparatus for video processing, wherein the method comprises:
obtaining a plurality of weights, wherein the plurality of weights are used to weight a plurality of values for a metric at respective samples in a target region for a bi-directional optical flow (BDOF) process applied on a current video block of the video, the metric comprises at least one of a gradient or a difference of sample values, and the plurality of values for the metric are determined based on a plurality of reference video blocks of the current video block; and
generating the bitstream based on the plurality of weights.
